(19) United States
(12) Patent Application Publication
(10) Pub. No.: US 2025/0066511 A1
(43) Pub. Date: Feb. 27, 2025

(54) CELLULOSE PARTICLES

(71) Applicant: SEPRIFY AG, Marly (CH)

(72) Inventors: Han YANG, Cambridge (GB); Giovanni IACUCCI, Cambridge (GB); Camila HONORATO-RIOS, Cambridge (GB); Lukas SCHERTEL, Cambridge (GB); Silvia VIGNOLINI, Cambridge (GB)

(73) Assignee: SEPRIFY AG, Marly (CH)

(21) Appl. No.: 18/728,739

(22) PCT Filed: Jan. 13, 2023
(86) PCT No.: PCT/EP2023/050756

§ 371 Date: Jul. 12, 2024

(30) Foreign Application Priority Data
Jan. 14, 2022 (GB) 2200462.6

(51) Int. Cl. C08B 15/02; C08B 1/00; C09D 17/00

(52) U.S. Cl. CPC C08B 15/02; C08B 1/00; C09D 17/003

(57) ABSTRACT

A cellulose particle having a length of from 1,000 to 10,000 nm and an aspect ratio of from 2 to 18 and a method for preparing cellulose particles including hydrolysing a cellulose material to provide hydrolysed cellulose particles, washing the hydrolysed cellulose particles, and fractioning the hydrolysed cellulose particles using differential centrifugation. A material includes the cellulose particles such as a film or cluster, a composition includes the cellulose particles or material including cellulose particles, and the use of the particles or materials in a composition. The particles may be used as white pigments, whiteness enhancers, scattering enhancers or opacifiers, due to their ability to provide excellent diffuse whiteness and opacity.

### RELATED APPLICATIONS

This application claims priority to, and the benefit of, GB 2200462.6 filed on 14 Jan. 2022 (14 January 2022), the contents of which are hereby incorporated by reference in their entirety.

### FIELD OF THE INVENTION

The present invention relates to a cellulose particle, a method for preparing cellulose particles and a cellulose particle prepared by the same. The invention also relates to a material comprising the cellulose particles such as a film or cluster, a composition comprising the cellulose particles or material comprising cellulose particles, and the use of the particles or materials in a composition.

### BACKGROUND

White materials scatter substantially all wavelengths of visible light with roughly equal strength. Such white colorants are used in paints, paper, cosmetics, food, photovoltaic devices and personal care products to enhance the whiteness of products. Traditionally, high-refractive index inorganic nanoparticles such as titanium oxide nanoparticles are used as white pigments (Tao et al.). However, concerns about environmental bioaccumulation, and recent investigations into potential carcinogenicity (Bettini et al.) mean that alternative white colourants are needed.

The appearance of white non-absorbing materials can be designed by engineering the internal structure of the material at the nano- and micro-scale. For example, light scattering particles like titanium dioxide nanoparticles are assembled into macroscale structures. Controlling the size and morphology of these scattering enhancers may produce materials with different appearances—by altering the opacity and whiteness.

A few titanium-dioxide-free highly scattering materials have been developed either using polymeric materials (Syurik et al.) or biopolymers such as cellulose derived nanofibers or nanocrystals (Toivonen et al.). Cellulose nanocrystals typically are 3-5 nm in width and 100-200 nm in length. However, these known materials are limited in their scattering performance.

There is therefore a need for white materials which have a low cost, and improved biocompatibility and sustainability compared to traditional white colorants such as titanium dioxide nanoparticles. Cellulose nanoparticles have been shown to have good biocompatibility (Credou et al. and Miyamoto et al.). There is also a need for these alternatives to have excellent and highly customizable scattering performance of visible light, whiteness, and opacity, to suit a wide variety of applications. These applications include in food additives, cosmetics, personal care products, pharmaceuticals, inks, paints, washing powders, opacifiers, light harvesting devices (such as photovoltaic cells) and light distribution devices (such as LEDs).

WO 2019/063647 and Toivonen et al. describes cellulose nanofibrils of various thicknesses and provides three example fibrils having widths of 4.2 nm, 5.6 nm and 19.5 nm respectively (Table 1, page 20 of WO 2019/063647). These particles have a relatively low width. The length and the aspect ratio of the cellulose nanofibrils is not explicitly disclosed, however the SEM images in FIGS. 4 and 5 of WO 2019/063647 confirm the fibrous nature of the nanofibrils. Also, FIG. 1S of the supporting information of Toivonen et al. confirms that the cellulose is highly fibrous.

The fibrous nature means that the nanofibrils have a high length (around 1 to 15 μm) compared to their width (around 3-20 nm), and thus have a high aspect ratio (around 1000). Typically, cellulose nanofibres are 3-20 nm in width and a few micrometres in length.

The preparation described in WO 2019/063647 and Toivonen et al. also involves several solvent exchange steps to produce the nanofibrils. In the preparation of the nanofibrils the solvent was exchanged from water to ethanol, and then from ethanol to 2-propanol, and then further from 2-propanol to octane for the preparation of the film of cellulose nanofibrils. This solvent exchange process is slow and requires large volumes of solvents, meaning the process is not easily scalable.

### SUMMARY OF THE INVENTION

In general, the invention provides cellulose particles having a preterminal size (length) and a low aspect ratio. The inventors have surprisingly found that cellulose particles having this geometry are excellent at scattering the full spectrum of visible light, achieving excellent reflection of white light and excellent luminosity. The particles are thus particularly suitable for use as white pigments, white enhancers, scattering enhancer and opacifiers. These finds applications in inks, paints, cosmetics, food, pharmaceuticals and the like. Scattering enhancers are particular useful for light distribution devices (such as in LEDs) or light harvesting components (such as photovoltaic cells).

The cellulose-based microparticles (CMPs) of the present invention are distinct from known cellulose nanomaterials, such as cellulose nanofibers and nanocrystals. The CMPs of the present invention have a larger width and a smaller aspect ratio than nanofibers and nanocrystals, to optimize the interaction with the wavelength of the visible spectrum of light. By tuning the size of the microparticles in this way, scattering performances can be optimized on the single scatter level.

Moreover, by additionally controlling the spatial arrangement of the CMPs in a disordered network, highly scattering materials can be produced which outperform current materials.

Films or clusters prepared from the CMPs show improved scattering and reflectance compared to films of cellulose nanofibers and cellulose nanocrystals.

These new class of cellulose particles are suitable for a wide variety of optical applications. The particles are manufactured from cellulose, so are more sustainable than known titanium dioxide scattering particles. The invention also has excellent biocompatibility, since cellulose is a natural material (e.g. from wood or cotton). The invention is thus particularly suitable for use in consumables, such as food or pharmaceutical coatings. Cellulose is widely available from natural sources as well as recycled material (e.g. paper), so the cost of materials should be comparable to, or lower than, traditional pigments such as titanium dioxide nanoparticles.

Moreover, compared to traditional processes for preparing cellulose nanofibers and nanocrystals, the production processes of the present invention are more energy efficient and more readily scalable. This is because the process does not require a solvent exchange step, which has previously been essential to produce porous scattering cellulosic materials (Toivonen et al.).

Generally, the invention provides a cellulose particle having a length of from 300 to 10,000 nm and an aspect ratio of from 2 to 20.

In a first aspect of the invention there is provided a cellulose particle having a length of from 1000 to 10,000 nm and an aspect ratio of from 2 to 18.

In some embodiments the cellulose particle has a width of from 100 to 1000 nm. Preferably, the cellulose particle has a width of from 200 to 1,000 nm, more preferably 200 to 800 nm, yet more preferably from 300 to 600 nm, even more preferably from 450 to 550 nm.

In addition, or alternatively, the invention provides cellulose particles, having a mean average length of from 1,000 to 10,000 nm and a mean average aspect ratio of from 2 to 18. Preferably the cellulose particle has a width of from 200 to 1,000 nm. Preferably, the cellulose particles have a D50 length of from 1,000 to 10,000 nm and a D50 aspect ratio of from 2 to 18. The cellulose particles may also a D50 width of 200 to 1,000 nm.

Generally, the invention provides a method of preparing a cellulose particle, the method comprising:
(a) hydrolysing a cellulose material to provide hydrolysed cellulose particles;
(b) washing the hydrolysed cellulose particles; and
(c) fractioning the hydrolysed cellulose particles.

In a second aspect of the invention there is provided a method of preparing a cellulose particle, the method comprising:
(a) hydrolysing a cellulose material with a protic inorganic acid having a concentration of from 40 to 60 v/v % at a temperature of from 40 to 60° C. to provide hydrolysed cellulose particles;
(b) washing the hydrolysed cellulose particles; and
(c) fractioning a suspension of the hydrolysed cellulose particles using differential centrifugation comprising a first centrifugation and a second centrifugation, wherein the first centrifugation is at a lower relative centrifugal force than the second centrifugation.

In some embodiments, the first centrifugation is at a relative centrifugal force of from 50 to 1,500 and the second centrifugation is at a relative centrifugal force of from 600 to 2,600.

In some embodiments of the invention there is provided a method of preparing a cellulose particle, the method comprising:
(a) hydrolysing a cellulose material with sulfuric acid having a concentration of from 40 to 60 v/v % at a temperature of from 40 to 60° C. to provide hydrolysed cellulose particles;
(b) washing the hydrolysed cellulose particles; and
(c) fractioning a suspension of the hydrolysed cellulose particles using differential centrifugation comprising a first centrifugation at a speed of from 1,000 to 3,000 rpm and a second centrifugation at a speed of from 2,000 to 4,000 rpm, wherein the first centrifugation is at a lower speed than the second centrifugation.

In some embodiments, the method further comprises a step (d) of drying the fractionated cellulose particles.

In some embodiments, drying the fractionated cellulose particles comprises spray drying or freeze drying the fractionated cellulose particles to provide a dry powder of cellulose particles.

In some embodiments, drying the fractionated cellulose particles comprises spray drying or spray-freeze drying the fractionated cellulose particles to provide a cluster comprising the cellulose particles.

In a third aspect of the invention there is provided a cellulose particle obtained or obtainable by the method of the second aspect.

In a fourth aspect of the invention there is provided a cluster comprising cellulose particles of any of the first or third aspects.

In a fifth aspect of the invention there is provided a cluster obtained or obtainable by the method of the second aspect, wherein the fractionated cellulose particles are dried by spray drying or spray-freeze drying.

In a sixth aspect of the invention there is provided a film comprising the cellulose particles of the first or third aspects.

In a seventh aspect of the invention there is provided a composition comprising a suspension of cellulose particles of the first or third aspects, a suspension of clusters of the fourth or fifth aspects, or a suspension of flakes formed by dividing the film of the sixth aspect.

In an eighth aspect of the invention there is provided a use of the cellulose particles of the first or third aspects, the cluster of the fourth or fifth aspects, or flakes formed by dividing the film of the sixth aspect, as a pigment, whiteness enhancer, scattering enhancer or opacifier.

These and other aspects and embodiments of the invention are described in further detail below.

### SUMMARY OF THE FIGURES

The present invention is described with reference to the figures listed below.

FIGS. 1a-1d shows STEM images of Comparative Example 3 (FIG. 1a), Example 2 (FIG. 1b), Example 1 (FIG. 1c), and Comparative Example 4 (FIG. 1d). FIG. 1e shows particle size distributions of the width distribution probability and FIG. 1f shows the particle size distributions of the length distribution probability for particles of Examples 1 [CMP-L] and 2 [CMP-M], and Comparative Examples 3 [CMP-S] and 4 [CMP-XL]. FIG. 1g shows a picture of light passing through a suspension of samples of (from left to right) Example 1, Example 2, Comparative Example 3, Comparative Example 4 (all at a concentration of 0.1 wt. %) and water. Illumination is from the front. FIG. 1h shows the reflectance of Example 1, Example 2, Comparative Example 3, Comparative Example 4 (all at a concentration of 0.1 wt. %).

FIG. 2 shows histograms and fitted log-normal distribution curves for the width and length of example CMPs. FIG. 2a shows the width of Example 1. FIG. 2b shows the width of Example 2. FIG. 2c shows the width of Comparative Example 3. FIG. 2d shows the width of Comparative Example 4. FIG. 2e shows the length of Example 1. FIG. 2f shows the length of Example 2. FIG. 2g shows the length of Comparative Example 3. FIG. 2h shows the length of Comparative Example 4.

FIG. 3a shows a picture of a typical white film (9 μm in thickness) made from CMPs of Example 1 F. FIG. 3b shows SEM image of the cross-section of the white film of Example 1 F, shown in FIG. 3a. FIG. 3c shows the reflectance of white films of Example 1 F [CMP-L], Example 2F [CMP-M] and Comparative Example 3F [CMP-S] at a thickness of 25 μm and a filling fraction of 25%. FIG. 3d shows the angular distribution of the intensity (wavelength=400 nm) reflected by film of Example 1F having a thickness of 10 μm and 40 μm.

FIG. 4a shows the total transmission data for films of Example 1 F, having a filling fraction of 40% and thicknesses of 10 μm, 15 μm, 20 μm and 30 μm. FIG. 4b shows a fitted curve of the total transmission verses thickness at a wavelength of 400 nm for a film of Example 1 F, having a filling fraction of 40%. FIG. 4c shows the spectral dependency of the transport mean free path for a film of Example 1F.

FIGS. 5a-5d show SEM images of the cross-section of white films made of CMPs having a filling fraction of 53%. FIG. 5a and FIG. 5b show an SEM image of Example 1F, FIG. 5c of Example 2F and FIG. 5d of Comparative Example 3F. FIG. 5e shows the reflectance of white films of Example 1 F, with a thickness of 9 μm at a filling fraction of 53% and 40%. FIG. 5f shows a polar plot showing the CIELAB colour space coordinates of the spectra in panel for Example 1 F [CMP-L] (at a filling fraction of 53% and 40%), Example 2F [CMP-M] and Comparative Example 3F [CMP-S].

FIG. 6a shows a schematic of the process for preparation of hydrophobic films of the CMPs, such as for Example 1 FH, where the film is directly dried in the air. FIG. 6b shows the reflectance of the hydrophobic films of Example 1 FH, and the inset images show the SEM image of the cross-section of the hydrophobic films of Example 1 FH and a contact angle profile of water droplet on the surface of hydrophobic film of Example 1 FH.

FIG. 7 shows a schematic of the vacuum process of fabrication of free-standing films from cellulose particles, such as Examples 1 F, 2F and Comparative Examples 3F and 4F.

FIG. 8 shows a schematic of the experimental setup for measuring reflectance and transmittance of the scattering particles. T₁ is the total light transmitted without a sample, T₂ is the total light transmitted with a sample, T₃ is the light scattered by the instrument and T₄ is the light scattered by the instrument and sample.

FIG. 9a shows an image of a dried CMP powder after freeze-drying. FIG. 9b shows an image of a dried CMPs powder redispersed in water to form an aqueous suspension after ultrasonication. FIG. 9c shows an SEM image of dried CMPs powder redispersed in water to form an aqueous suspension after ultrasonication. FIG. 9d shows an SEM image of a CMP cluster prepared by spray-drying an aqueous CMP suspension.

### DETAILED DESCRIPTION OF THE INVENTION

### Cellulose Particles

Generally, the invention provides a cellulose particle having a length of from 300 to 10,000 nm, wherein the ratio between the length of the particle and the width of the particle is from 2 to 20.

In a first aspect the invention provides a cellulose particle having a length of from 1,000 to 10,000 nm, wherein the ratio between the length of the particle and the width of the particle is from 2 to 18.

Typically, the particles have a width of from 100 to 1,000 nm. Preferably the particles have a width of 200 to 1,000 nm.

The shape and size of the cellulose particles may be produced by the methods described herein. Accordingly, the invention also provides a cellulose particle obtained or obtainable by the methods of the invention.

In addition, or alternatively, the invention provides a cellulose particle, wherein a population of the cellulose particles have a mean average length of from 1,000 to 10,000 nm and a mean average aspect ratio of from 2 to 18. Preferably, the population of the cellulose particles has a D50 length of from 1,000 to 10,000 nm and a D50 aspect ratio of from 2 to 18.

The population of cellulose particles may have a mean average width of from 100 to 1,000 nm, such as 200 to 1,000 nm. Preferably, the population of cellulose particles may have a D50 width of from 100 to 1,000 nm, such as 200 to 1,000 nm.

Particles of cellulose are known in the art. However, the cellulose nanoparticles described previously are typically shorter in length than the cellulose microparticles of the present invention. The cellulose nanofibres described previously are also typically shorter in width and than the cellulose microparticles of the present invention. In the case of cellulose nanofibres and microfibres described previously, the fibrous morphology results in a much higher aspect ratio than the cellulose microparticles of the present invention.

US 2021/213405 describes cellulose nanocrystals having a length of 344 nm and an aspect ratio of 13.76.

WO 2012/06720 describes “cellulose nanowhiskers” having a length of 300 nm and width of 21 nm, and thus an aspect ratio of about 14.

CN 113152150 describes cellulose nanoparticles and nanofibres having an aspect ratio of 15 or more and a length of 300 nm or less.

CN 113174091 relates to a composite film formed from cellulose nanocrystals and an insoluble protein from tea. The particles have a length of 100 to 600 nm and a diameter of 5 to 50 nm.

CN 112280072 describes cellulose particles having a length of 100 to 400 nm and a width of 20 to 50 nm.

CN 102276734 describes cellulose particles having a length of 300 to 400 nm and a width of 30 to 50 nm.

CN 113480756 describes cellulose particles having a length of 200 to 400 nm and a width of 25 to 40 nm. The films described in CN 113480756 are also coloured, so do not have the white uniform scattering properties of the present invention.

EP 3854819 describes cellulose nanocrystals and nanofibers. The nanocrystals have a width of 50 nm or less and an aspect ratio of 5 to 50. The nanofibers have a maximum width of 50 nm and an aspect ratio of 10 or more. At an aspect ratio of 18 and a width of 50 nm, the nanocrystals and nanofibres described have a length of only 900 nm, which is less than the particles of the present invention.

US 2013/303750 describes the preparation of cellulose nanofibers and nanocrystals having a length of 100 to 5000 nm and a width of 5 to 200 nm (see Examples and Figures). The fibrous cellulose prepared generally has a lower width, and a higher aspect ratio than the present invention. US 2013/303750 concerns cellulose particles as structural materials, and does not test the optical properties of the particles.

CN 113150319 relates to self-healing hydrogels, including functionalised cellulose nanocrystals. The cellulose particles have a length of 3 to 1,000 nm and an aspect ratio of 1 to 20, so are generally shorter in length at the same aspect ratio than the particles of the present invention.

CN 106699904 concerns hyperbranched cellulose nanofibers, having a length of 100 to 1,000 nm and a diameter of 10 to 40 nm. The hyperbranched fibres are more branched than the cellulose particles of the invention, which are preferably rod- or flake-shaped. The cellulose nanofibres are also shorter than the microparticles of the invention and have a higher aspect ratio at their maximum length.

The cellulose particles of the invention may be characterised by the following properties.

The width of the particle is generally the shortest dimension of the particle. For example, if the particle is rod shaped, then the width is the diameter of the cross-section of the rod. The width of the particle is typically the lateral diameter of the particle. The width may also be referred to as the diameter.

The particles are typically not spherical, as the aspect ratio is greater than 1 (e.g. from 2 to 18). The particles may be described as prismatic and/or elongate. Preferably the particles are rod shaped.

The width of the particle is typically the shortest lateral dimension of the particle. The lateral dimension is the shortest dimension observable when viewing a particle in plan view. The particles in plan view appear to be two dimensional. For example, if the particle is measured from a top down (or plan) image, then width is the shortest dimension measurable from the top down image of the particle.

The width of the particle is generally the shortest dimension of the particle which is perpendicular to a line defining the length dimension of the particle. As explained below, the length of the particle is the longest dimension of the particle, and so the line defining the length of the particle is the line between the furthest extremities of the particle. The width may be the shortest dimension of the particle which is perpendicular to the line defining the length of the particle. The shortest dimension may also be defined by a line between the closest extremities of the particle, wherein the line is perpendicular to the line defining the length of the particle. In other words, the shortest dimension may be the narrowest section of the particle which can be joined by a line perpendicular to the line defining the length of the particle.

The width of the particles may be determined using standard techniques. For example, scanning electron microscope (SEM) may be used. Suitable systems include a Mira3 system (TESCAN) operated at 30 kV and a working distance of 5 mm. The width of microparticles may be analysed by ImageJ.

In some embodiments, the width of the particles is measured using SEM.

The number of measurements of width taken is typically from 100 to 1,000. Generally, over 100 measurements of width are taken. The width is typically the mean average value of the measurements taken. By calculating a mean average value for the width, the effect of anomalous values is reduced, and the representative width of the particle is indicated.

Typically, the cellulose particle has a width of from 100 to 1,000 nm, such as 200 to 1,000 nm. Preferably the cellulose particle has a width of from 200 to 800 nm, more preferably from 300 to 600 nm, even more preferably from 450 to 550 nm.

In a first embodiment, herein known as a “large cellulose microparticle” the cellulose particle has a width of from 200 to 800 nm, preferably from 300 to 600 nm, more preferably from 450 to 550 nm, even more preferably from 500 to 540 nm.

In a second embodiment, herein known as a “medium cellulose microparticle”, the cellulose particle has a width of from 100 to 500 nm, preferably from 150 to 300 nm, more preferably from 180 to 250 nm, even more preferably from 200 to 230 nm.

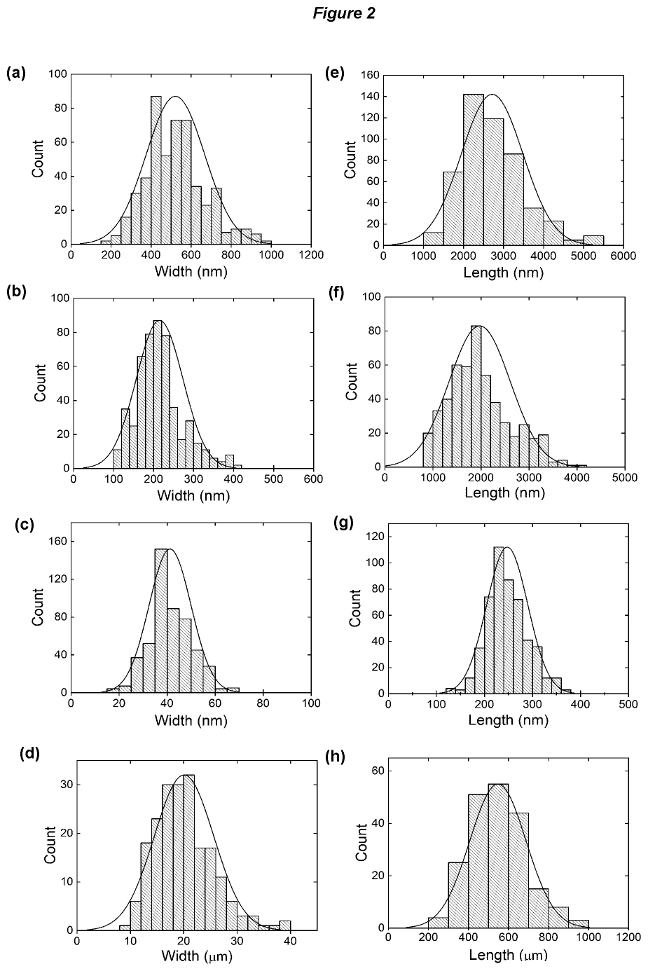

Typically, the width of a population of particles gives a particle size distribution having a log-normal distribution. Generally, the population of particles has a monomodal particle size distribution. A monomodal particle size distribution has only one peak or maxima in the particle size distribution. Typically, the peak of the monomodal distribution corresponds to the modal average particle diameter by number for all particles in the distribution. An example particle size distribution is shown in FIG. 2.

Percentile values for the width from the particle size distribution can also be calculated, such as D100, D90, D50 and D10. These values may be calculated based on the width particle size distribution on the basis of the number of particles.

D100 width is the particle width at which 100% of the particles have a width less than or equal to the D100 particle width.

In some embodiments the cellulose particles have a D100 width of 2,000 nm or less, preferably 1,500 nm or less, preferably 1,000 nm or less. In some embodiments the cellulose particles have a D100 width of 500 nm or more, preferably 800 nm or more, preferably 1,000 nm or more. In some embodiments the cellulose particles have a D100 width of from 400 to 2,000 nm, preferably from 500 to 1,200 nm, preferably from 600 to 1,000 nm.

In a first embodiment the D100 width is about 1,000 nm.

In a second embodiment the D100 width is about 450 nm.

D90 width is the particle width at which 90% of the particles have a width less than or equal to the D90 particle width.

In some embodiments the cellulose particles have a D90 width of 1,000 nm or less, preferably 900 nm or less, preferably 800 nm or less. In some embodiments the cellulose particles have a D90 width of 250 nm or more, preferably 300 nm or more, preferably 350 nm or more. In some embodiments the cellulose particles have a D90 width of from 300 to 1,000 nm, preferably from 350 to 900 nm.

In a first embodiment the D90 width is about 850 nm.

In a second embodiment the D90 width is about 350 nm.

D50 width is the particle width at which 50% of the particles have a width less than or equal to the D50 particle width.

In some embodiments the cellulose particles have a D50 width of 800 nm or less, preferably 700 nm or less, preferably 600 nm or less. In some embodiments the cellulose particles have a D50 width of 100 nm or more, preferably 150 nm or more, preferably 200 nm or more. In some embodiments the cellulose particles have a D50 width of from 200 to 800 nm, preferably from 300 to 600 nm, preferably from 450 to 550 nm.

In a first embodiment the D50 width is from 500 to 540 nm, such as about 520 nm.

In a second embodiment the D50 width is from 200 to 240 nm, such as about 220 nm.

D10 width is the particle width at which 10% of the particles have a width less than or equal to the D10 particle width.

In some embodiments the cellulose particles have a D10 width of 400 nm or less, preferably 300 nm or less, preferably 200 nm or less. In some embodiments the cellulose particles have a D10 width of 50 nm or more, preferably 100 nm or more, preferably 200 nm or more. In some embodiments the cellulose particles have a D10 width of from 50 to 400 nm, preferably from 100 to 300 nm, preferably from 150 to 200 nm.

In a first embodiment the D10 width is about 300 nm.

In a second embodiment the D10 width is about 150 nm.

In some embodiments, the population of particles has a low width standard deviation. This is indicative of a narrow particle width distribution. In some embodiments, the width standard deviation for the population of particles is 300 nm or less, preferably 250 nm or less, more preferably 200 nm or less, even more preferably 150 nm or less, yet more preferably 100 nm or less. In some embodiments, the width standard deviation for the population of particles is from 30 to 300 nm, preferably from 40 to 250 nm, more preferably from 50 to 200 nm, even more preferably from 60 to 160 nm.

In some embodiments, the width standard deviation is 50% or less, preferably 40% or less, more preferably 35% or less, yet more preferably 30% or less

In a first embodiment, the width standard deviation for the population of particles is 300 nm or less, preferably 250 nm or less, preferably 200 nm or less, more preferably 180 nm or less, even more preferably 160 nm or less. In a first embodiment, the width standard deviation for the population of particles is from 100 to 200 nm, more preferably from 120 to 180 nm, even more preferably from 140 to 160 nm.

In a second embodiment, the width standard deviation for the population of particles is 300 nm or less, preferably 250 nm or less, preferably 200 nm or less, more preferably 150 nm or less, even more preferably 100 nm or less. In a second embodiment, the width standard deviation for the population of particles is from 30 to 120 nm, preferably from 40 to 100 nm, more preferably from 50 to 70 nm, even more preferably from 60 to 70 nm.

The length of the particle is generally the longest dimension of the particle. For example, if the particle is rod shaped, then the length is the length between the ends of the rod. The length of the particle is typically the longitudinal length of the particle.

The length of the particle is typically the longest lateral dimension. The lateral dimension is the dimension observable when viewing a particle in plan view. The particles in plan view appear to be two dimensional. For example, if the particle is measured from a top down (or plan) image, then length is the longest dimension measurable from the top down image of the particle.

The length of the particles may be measured using standard techniques. For example, scanning electron microscope (SEM) may be used. Suitable systems include a Mira3 FEG-SEM system (TESCAN) operated at 30 kV and a working distance of 5 mm. The length of the microparticles may then be analysed by ImageJ.

Typically, the length of the particles is measured using SEM.

The number of measurements taken of the length is typically from 100 to 1,000. Generally, over 100 measurements of the length are taken. The length is the mean average value of the measurements taken. By calculating a mean average value for the length, the effect of anomalous values is reduced, and the representative length of the particle is indicated.

Typically, the cellulose particle has a length of from 300 to 10,000 nm. Preferably the cellulose particle has a length of from 1,000 to 5,000 nm, more preferably from 1300 to 3,500 nm, even more preferably from 1,600 to 3,000 nm, and most preferably from 1900 to 2,800 nm.

In a first embodiment (large cellulose microparticle) the cellulose particle has a length of from 1,000 to 5,000 nm, preferably from 1,900 to 3,500 nm, more preferably from 2,200 to 3,000 nm, even more preferably from 2,500 to 2,900 nm, and most preferably from 2,600 to 2,800 nm.

In a second embodiment (medium cellulose microparticle) the cellulose particle has a length of from 1,000 to 4,000 nm, preferably from 1,200 to 2,700 nm, more preferably from 1,500 to 2,500 nm, even more preferably from 1,700 to 2,300 nm, yet more preferably from 1,800 to 2,100 nm, most preferably from 1,900 to 2,000 nm.

Typically, the length of a population of particles gives a particle size distribution having a log-normal distribution. Generally, the population of particles has a monomodal particle size distribution, which has only one peak or maxima in the particle size distribution. The peak or maximum of the monomodal distribution corresponds to the median average particle diameter by number for all particles in the distribution. An example particle size distribution is shown in FIG. 2.

Percentile values for the length from the particle size distribution can also be calculated, such as D100, D90, D50 and D10. These values may be calculated based on the length particle size distribution on the basis of the number of particles.

D100 length is the particle length at which 100% of the particles have a length less than or equal to the D100 particle length.

In some embodiments the cellulose particles have a D100 length of 8,000 nm or less, preferably 6,500 nm or less, preferably 5,000 nm or less. In some embodiments the cellulose particles have a D100 length of 4,000 nm or more, preferably 5,000 nm or more, preferably 6,000 nm or more. In some embodiments the cellulose particles have a D100 length of from 4,000 to 6,000 nm, preferably from 4,500 to 5,500 nm.

In a first embodiment the D100 length is about 5,500 nm.

In a second embodiment the D100 length is about 4,250 nm.

D90 length is the particle length at which 90% of the particles have a length less than or equal to the D90 particle length.

In some embodiments the cellulose particles have a D90 length of 6,000 nm or less, preferably 5,000 nm or less, preferably 4,500 nm or less. In some embodiments the cellulose particles have a D90 length of 3,000 nm or more, preferably 3,500 nm or more, preferably 3,750 nm or more. In some embodiments the cellulose particles have a D90 length of from 3,000 to 5,000 nm, preferably from 3,500 to 4,500 nm.

In a first embodiment the D90 length is about 4,500 nm.

In a second embodiment the D90 length is about 3,500 nm.

D50 length is the particle length at which 50% of the particles have a length less than or equal to the D50 particle length.

In some embodiments the cellulose particles have a D50 length of 5,000 nm or less, preferably 3,500 nm or less, preferably 3,000 nm or less, more preferably 2,800 nm or less. In some embodiments the cellulose particles have a D50 length of 1,000 nm or more, preferably 1,300 nm or more, preferably 1,600 nm or more, more preferably 1900 nm or more. In some embodiments the cellulose particles have a D50 length of from 1,000 to 5,000 nm, preferably from 1,300 to 3,500 nm, preferably from 1,600 to 3,000 nm, more preferably from 1,900 to 2,800 nm.

In a first embodiment the D50 length is from 1,000 to 5,000 nm, preferably from 1,900 to 3,500 nm, more preferably from 2,200 to 3,000 nm, even more preferably from 2,500 to 2,900 nm, and most preferably from 2,600 to 2,800 nm. In a first embodiment the D50 length is preferably about 2,700 nm.

In a second embodiment the D50 length is from 1,000 to 4,000 nm, preferably from 1,200 to 2,700 nm, preferably from 1,500 to 2,500 nm, preferably from 1,700 to 2,300 nm, preferably from 1,800 to 2,100 nm, more preferably from 1,900 to 2,000 nm. In a second embodiment the D50 length is preferably about 1,950 nm.

D10 length is the particle length at which 10% of the particles have a length less than or equal to the D10 particle length.

In some embodiments the cellulose particles have a D10 length of 2,000 nm or less, preferably 1,750 nm or less, preferably 1,500 nm or less. In some embodiments the cellulose particles have a D10 length of 500 nm or more, preferably 750 nm or more, preferably 1,000 nm or more. In some embodiments the cellulose particles have a D10 length of from 500 to 2,000 nm, preferably from 750 to 1,800 nm, preferably from 1,000 to 1,700 nm.

In a first embodiment the D10 length is about 1,700 nm.

In a second embodiment the D10 length is about 1,200 nm.

In some embodiments, the population of particles has a low length standard deviation. This is indicative of a narrow particle length distribution. In some embodiments, the length standard deviation for the population of particles is 1,500 nm or less, preferably 1,000 nm or less, more preferably 800 nm or less, even more preferably 800 nm or less, yet more preferably 700 nm or less. In some embodiments, the length standard deviation for the population of particles is from 400 to 1,500 nm, preferably from 500 to 1,000 nm, more preferably from 600 to 800 nm.

In some embodiments, the length standard deviation is 50% or less, preferably 40% or less, more preferably 35% or less, yet more preferably 30% or less.

In a first embodiments, the length standard deviation for the population of particles is 1,500 nm or less, preferably 1,000 nm or less, more preferably 900 nm or less, even more preferably 800 nm or less. In a first embodiment, the length standard deviation for the population of particles is from 500 to 1,000 nm, more preferably from 600 to 900 nm, even more preferably from 700 to 800 nm.

In a second embodiments, the length standard deviation for the population of particles is 1,000 nm or less, preferably 800 nm or less, more preferably 700 nm or less. In a second embodiment, the length standard deviation for the population of particles is from 300 to 1,000 nm, preferably from 400 to 800 nm, more preferably from 500 to 750 nm, even more preferably from 600 to 700 nm.

The aspect ratio is the ratio between the length of the particle and the width of the particle. This is generally the ratio between the longest dimension of the particle and the shortest dimension of the particle. Typically, the longest dimension of the particle is the length of the particle, such as the shortest lateral dimension. Typically, the shortest dimension of the particle is the width of the particle, such as the longest lateral dimension. The length and width of the particle may be determined as set out above.

For example, a particle having a length of 3,000 nm and a width of 500 nm would have an aspect ratio of (3,000/500=) 6. For a perfectly spherical particle, where the length and width of the particle are equal, the aspect ratio is 1.

Typically, the aspect ratio of the cellulose particle is from 2 to 18. Preferably, the aspect ratio of the cellulose particle is from 3 to 15, more preferably from 4 to 10, and most preferably from 4 to 6.

In a first embodiment (large cellulose microparticle) the aspect ratio of the cellulose particle is from 2 to 10, preferably from 3 to 8, more preferably from 4 to 6.

In a second embodiment (medium cellulose microparticle) the aspect ratio of the cellulose particle is from 4 to 18, preferably from 6 to 12, more preferably from 8 to 10.

The aspect ratio may also be the ratio between the length of a population of particles and the width of a population of particles. In some embodiments, the aspect ratio is a D50 aspect ratio, which is the ratio between the D50 length and the D50 width. In some embodiments, the aspect ratio is a mean average aspect ratio, which is a ratio between the mean average length and the mean average width.

The mean average aspect ratio may be from 2 to 18. Preferably, the mean average aspect ratio of the cellulose particle is from 2 to 16, more preferably 3 to 14, even more preferably from 4 to 10, and most preferably from 4 to 6.

The D50 aspect ratio may be from 2 to 18. Preferably, the D50 aspect ratio of the cellulose particle is from 2 to 16, more preferably 3 to 14, even more preferably from 4 to 10, and most preferably from 4 to 6.

The cellulose particle may have any suitable shape. In some embodiments, the cellulose particle has a rod or a rod-like shape, or a flake or flake-like shape. In some embodiments, the cellulose particle has a rod or a flake shape.

The cellulose particle may have a rod or a rod-like shape. Thus, the width may be the diameter of the cross-section of the rod. The particle may be elongate with a length dimension greater than the width dimension.

The cellulose particle may also have a flake or flake-like shape. The flake or flake-like shape may be elongate, with a length dimension greater than the width dimension. The flake or flake-like shape typically has a uniform height over most of the length of the particle.

The cellulose particle may be substantially unbranched. That is, the cellulose particle is typically not divided into two or more branches. The cellulose particle is preferably not a branched cellulose particle and not a hyperbranched cellulose particle.

The cellulose particle preferably has a particulate morphology. That is, the shape of the cellulose is particle-like, and is distinct from a fibrous cellulose. Preferably, the cellulose particle is not a cellulose fibre.

The cellulose particle is typically a primary particle. That is, the cellulose particle is not an agglomeration of smaller particles. Agglomerations of the cellulose particles are discussed in the clusters section.

The cellulose particles have excellent optical properties. In particular, the cellulose particles can provide high reflectance. For example, a suspension of the cellulose particles in water has high reflectance of white light.

The optical properties of the particles can be measured using standard techniques, such as using a light source coupled with a spectrometer and an integrating sphere. A suitable set-up is shown in FIG. 8. The signal can be normalized with respect to the intensity in the absence of sample. Typically, a white diffuser standard is used, such as a Labsphere SRS-99-010. The background can be recorded when no light is applied, and the background noise can be subtracted from the measurements. The optical properties are measured in the visible range (e.g., from 400 nm to 800 nm). Typically, the optical properties are measured in air. Transmittance may be measured, and reflectance calculated from the obtained transmittance values assuming that there is no absorption by the particles. Typically, five spectra were taken for each sample and averaged.

In some embodiments the total transmittance and reflectance measurements were performed with an integrating sphere (Labsphere). A light source (Ocean Optics HPX-2000) was coupled into an optical fiber (600 μm Thorlabs FC-UV100-2-SR) via a collimator (Thorlabs) and the signal was collected by a spectrometer (Avantes HS2048), as shown in FIG. 8 (T₁ and T₂). The signal was normalized with respect to the intensity when no sample was mounted. The background was recorded when no light was applied. The range of wavelengths was between 400 and 800 nm. Five spectra were taken for each sample and averaged to reduce the signal-to-noise ratio. Each spectrum was recorded using an integration time equal to 3 s.

The particles may be provided as a suspension in water. For measurement of reflectance and transmittance, the particle suspension in water is typically contained in a cuvette. The cuvette may have a light path length of 1 cm. The light path length may be referred to as the ‘sample thickness’ of the particle suspension. The ‘sample thickness’ may be 1 cm.

An average reflectance is generally the mean average of reflectance values taken over a range of wavelengths. For example, an average reflectance over a wavelength range of from 400 to 800 nm is the mean average of the reflectance values taken at wavelengths of from 400 to 800 nm. The reflectance values are typically taken at regular intervals over the range of wavelengths, such as at 1 nm or 5 nm intervals.

Typically, the cellulose particles have a reflectance of 25% or more, such as when the cellulose particles are dispersed in water at a concentration of 0.1 wt % and a sample light path length of 1 cm. Preferably the cellulose particles have a reflectance of 30% or more, more preferably 35% or more, such as when the cellulose particles are dispersed in water at a concentration of 0.1 wt. % and the light path length is 1 cm.

In a first embodiment (large cellulose microparticles) the cellulose particles have a reflectance of 45% or more, preferably 50% or more, more preferably 55% or more at a wavelength of from 400 to 800 nm, such as when the cellulose particles are dispersed in water at a concentration of 0.1 wt. % and the light path length is 1 cm.

In a first embodiment (large cellulose microparticles) the cellulose particles have an average reflectance over a wavelength range of from 400 to 800 nm of 45% or more, preferably 60% or more, more preferably 65% or more, such as when the cellulose particles are dispersed in water at a concentration of 0.1 wt. % and the light path length is 1 cm.

In a second embodiment (medium cellulose microparticles) the cellulose particles have a reflectance of 25% or more, preferably 30% or more, more preferably 35% or more at a wavelength of from 400 to 800 nm, such as when the cellulose particles are dispersed in water at a concentration of 0.1 wt. % and the light path length is 1 cm.

In a second embodiment (medium cellulose microparticles) the cellulose particles have an average reflectance over a wavelength range of from 400 to 800 nm of 40% or more, preferably 45% or more, more preferably 50% or more, such as when the cellulose particles are dispersed in water at a concentration of 0.1 wt. % and the light path length is 1 cm.

At 500 nm, the cellulose particles typically have a reflectance of 45% or more, preferably 50% or more, more preferably 55% or more, such as when the cellulose particles are dispersed in water at a concentration of 0.1 wt. % and the light path length is 1 cm.

In a first embodiment (large cellulose microparticles), the cellulose particles have a reflectance at 500 nm of 60% or more, preferably 65% or more, more preferably 70% or more, such as when the cellulose particles are dispersed in water at a concentration of 0.1 wt. % and the light path length is 1 cm.

In a second embodiment (medium cellulose microparticles), the cellulose particles have a reflectance at 500 nm of 45% or more, preferably 50% or more, more preferably 55% or more, such as when the cellulose particles are dispersed in water at a concentration of 0.1 wt. % and the light path length is 1 cm.

At 600 nm, the cellulose particles have a reflectance of 40% or more, preferably 45% or more, more preferably 50% or more when the cellulose particles are dispersed in water at a concentration of 0.1 wt. % and the light path length is 1 cm.

In a first embodiment (large cellulose microparticles), the cellulose particles have a reflectance at 600 nm of 55% or more, preferably 60% or more, more preferably 65% or more, such as when the cellulose particles are dispersed in water at a concentration of 0.1 wt. % and the light path length is 1 cm.

In a second embodiment (medium cellulose microparticles), the cellulose particles have a reflectance at 600 nm of 40% or more, preferably 45% or more, more preferably 50% or more, such as when the cellulose particles are dispersed in water at a concentration of 0.1 wt. % and the light path length is 1 cm.

At 700 nm, the cellulose particles have a reflectance of 25% or more, preferably 30% or more, more preferably 35% or more when the cellulose particles are dispersed in water at a concentration of 0.1 wt. % and the light path length is 1 cm.

In a first embodiment (large cellulose microparticles), the cellulose particles have a reflectance at 700 nm of 50% or more, preferably 55% or more, more preferably 60% or more, such as when the cellulose particles are dispersed in water at a concentration of 0.1 wt. % and the light path length is 1 cm.

In a second embodiment (medium cellulose microparticles), the cellulose particles have a reflectance at 700 nm of 25% or more, preferably 30% or more, more preferably 35% or more, such as when the cellulose particles are dispersed in water at a concentration of 0.1 wt. % and the light path length is 1 cm.

In addition to high absolute reflectance values, the light reflected by the cellulose particles is also highly diffuse. Thus, the light is typically reflected at a similar level across the given wavelength range. There are also no significant or sharp peaks in the reflectance spectra.

It is thought that the cellulose particles have an asymmetric angular distribution of scattered light (Mie-scattering). This may explain the high scattering efficiency of the cellulose particles, compared to traditional cellulose particles having a small width and high aspect ratio, which are thought to have a symmetric angular distribution of scattered light (Rayleigh scattering).

The surface of the cellulose particles may be modified. Typically, the hydroxyl groups on the surface of the cellulose particle are modified. The cellulose particles may be modified to be hydrophobic or partially hydrophobic.

In some embodiments, one or more hydroxyl groups on the surface of the cellulose particle are modified. In some embodiment the hydroxyl groups are transformed into a different functional group, such as an ester or an ether group. Preferably the hydroxyl groups are converted into an ether group, such as a silylether group.

Typically, the hydroxyl groups are transformed by treating the cellulose particles with an esterification agent or an etherification agent. Preferably, the transformation is achieved by treating the cellulose particles with a hydrophobic agent. Generally, a hydrophobic moiety from the hydrophobic agent will be appended to the cellulose particle to impart hydrophobic character to the cellulose particle.

Preferably, one or more hydroxyl groups on the surface of the cellulose particle is substituted with a hydrophobic moiety. For example, the hydroxyl groups may be substituted with a trimethyl silane (TMS) group or a trimethoxysilane ((CH₃O)₃Si) group. In this way, the hydroxyl group is converted to a —O-TMS or (CH₃O)₃Si—O— group.

Without wishing to be bound by theory, it is thought that replacing a portion of the hydroxyl groups on the surface of the particle with hydrophobic group such as —O-TMS or (CH₃O)₃Si—O— reduces the hydrogen bonding between the hydroxyl groups so the pores or voids between the cellulose particles are less prone to collapse under capillary pressure, for example, during solvent evaporation. Thus, the particles are more robust when prepared as part of a cluster or film. The cluster or films comprising the cellulose particles may have an altered structure or filling fraction, hydrophobicity, strength or other physical property. The dispersibility of the particles in solution is also able to be customised, for example to increase dispersibility in non-polar solvents.

### Films

The invention also provides a film comprising the cellulose particles described herein.

The film may substantially consist of, such as consist essentially of, the cellulose particles as described herein. The film may be an agglomeration of cellulose particles, formed in a thin layer. Typically, the cellulose particles are held together by non-covalent interactions.

The film may be produced by the methods described herein. Accordingly, the invention provides a material obtained or obtainable by the methods of the invention.

In some embodiments, the cellulose particles are randomly distributed in the film.

Typically, the film includes pores or voids. The pores or voids are between the cellulose particles. The film may be said to be porous.

Typically, the shape of the pores is similar to the shape of the particles. The pores are generally elongate with a length dimension greater than the width dimension. The pores may have a similar width to the particles. The pores may have a similar length to the particles. The pores may have a similar aspect ratio to the particles.

The total volume of the pores equal to the total volume of a material (v₂) minus the volume of cellulose particles in the material (v₁).

Preferably, the film has a thickness (such as a dry thickness) which is large enough to provide a white and opaque film. Accordingly, the film typically has a thickness of from 1.0 μm to 50 μm, preferably from 5.0 μm to 40 μm, more preferably 7.0 to 30.0 μm, even more preferably 9.0 to 20.0 μm, and most preferably 9.0 to 12.0 μm. In some embodiments the film has a thickness of from 20 to 30 μm, such as around 25 μm.

The thickness of the material may be measured using standard techniques, such as measuring the thickness of a cross-section of the film using SEM.

The quantity of cellulose particles in the film can be estimated using the filling fraction (ff). The filling fraction (ff) is the ratio of the volume of cellulose particles in a material (v₁) to the total volume of the material (v₂).

The volume of cellulose particles in a material may be calculated using a nominal density p of 1.5 g/cm⁻³ for cellulose, where the volume of cellulose nanoparticles v₁=m/ρ (m is the weight of material). The volume of the material may be calculated by routine methods, based on measurements of the external dimensions of the material. For example, in the case of a circular film, which may be approximated as a cylinder, the formula v₂=πr²d, where d is the thickness of the film and r is the radius of the film, may be used.

The filling fraction is known to influence the optical properties of cellulose-based materials (for example, scattering efficiency and reflectance).

Typically, the film has a filling fraction of from 20 to 60%. Preferably the film has a filling fraction of from 25 to 55%, more preferably from 40 to 55%. Preferably the film has a filling fraction of about 50%.

The filling fraction and thickness of the film may be appropriately adjusted by changing the initial quantity of microparticles and the duration of the vacuum filtration process during film preparation (see below).

The optical properties of the films can be measured using standard techniques, such as using a light source coupled with a spectrometer and an integrating sphere. A suitable set-up is shown in FIG. 8. The signal can be normalized with respect to the intensity in the absence of sample. Typically, a white diffuser standard is used, such as a Labsphere SRS-99-010. The background can be recorded when no light is applied, and the background noise can be subtracted from the measurements. The optical properties are measured in the visible range (e.g. from 400 nm to 800 nm). Typically, the optical properties are measured in air. Transmittance may be measured, and reflectance calculated from the obtained transmittance values assuming that there is no absorption by the film. Typically, five spectra were taken for each sample and averaged.

An average reflectance is generally the mean average of reflectance values taken over a range of wavelengths. For example, an average reflectance over a wavelength range of from 400 to 800 nm is the mean average of the reflectance values taken at wavelengths of from 400 to 800 nm. The reflectance values are typically taken at regular intervals over the range of wavelengths, such as 1 nm or 5 nm intervals.

Typically, the film has a reflectance of 50% or more, preferably 55% or more, more preferably 60% or more for incoming light at a wavelength of from 400 to 800 nm, such as when the material has a filling fraction of 25% and a thickness of 25 μm.

In a third embodiment (large cellulose microparticle film) the film has a reflectance of 70% or more, preferably 75% or more, more preferably 80% or more at a wavelength of from 400 to 800 nm, such as when the film has a filling fraction of 25% and a thickness of 25 μm.

In a third embodiment (large cellulose microparticle film) the film has an average reflectance over a wavelength of from 400 to 800 nm of 73% or more, preferably 78% or more, more preferably 83% or more, such as when the film has a filling fraction of 25% and a thickness of 25 μm.

In a fourth embodiment (medium cellulose microparticle film) the film has a reflectance of 50% or more, preferably 55% or more, more preferably 60% or more at a wavelength of from 400 to 800 nm, such as when the film has a filling fraction of 25% and a thickness of 25 μm.

In a fourth embodiment (medium cellulose microparticle film) the film has an average reflectance over a wavelength of from 400 to 800 nm of 55% or more, preferably 60% or more, more preferably 65% or more at, such as when the film has a filling fraction of 25% and a thickness of 25 μm.

At 500 nm, the film typically has a reflectance of 65% or more, such as when the film has a filling fraction of 25% and a thickness of 25 μm. In a third embodiment (large cellulose microparticle film) the film has a reflectance at 500 nm of 85% or more. In a fourth embodiment (medium cellulose microparticle film) the film has a reflectance at 500 nm of 65% or more.

At 600 nm, the film typically has a reflectance of 62% or more, such as when the film has a filling fraction of 25% and a thickness of 25 μm. In a third embodiment (large cellulose microparticle film) the film has a reflectance at 600 nm of 82% or more. In a fourth embodiment (medium cellulose microparticle film) the film has a reflectance at 600 nm of 62% or more.

At 700 nm, the film typically has a reflectance of 60% or more, such when the film has a filling fraction of 25% and a thickness of 25 μm. In a third embodiment (large cellulose microparticle film) the film has a reflectance at 700 nm of 80% or more. In a fourth embodiment (medium cellulose microparticle film) the film has a reflectance at 700 nm of 60% or more.

Typically, the material has a reflectance of 55% or more, preferably 60% or more, more preferably 65% or more for incoming light at a wavelength of from 400 to 800 nm, such as when the material has a filling fraction of 40% and a thickness of 9 μm.

In a fifth embodiment (large cellulose microparticle film) the film has a reflectance of 55% or more, preferably 60% or more, more preferably 65% or more at a wavelength of from 400 to 800 nm, such as when the film has a filling fraction of 40% and a thickness of 9 μm.

In a fifth embodiment (large cellulose microparticle film) the film has an average reflectance over a wavelength of from 400 to 800 nm of 60% or more, preferably 65% or more, more preferably 70% or more at, such as when the film has a filling fraction of 40% and a thickness of 9 μm.

At 500 nm, the film typically has a reflectance of 60% or more, preferably 65% or more, more preferably 70% or more, such as when the film has a filling fraction of 40% and a thickness of 9 μm. In a fifth embodiment (large cellulose microparticle film) the film has a reflectance at 500 nm of 70% or more, such as when the film has a filling fraction of 40% and a thickness of 9 μm.

At 600 nm, the film typically has a reflectance of 60% or more, preferably 65% or more, more preferably 68% or more, such as when the film has a filling fraction of 40% and a thickness of 9 μm. In a fifth embodiment (large cellulose microparticle film) the film has a reflectance at 600 nm of 68% or more, such as when the film has a filling fraction of 40% and a thickness of 9 μm.

At 700 nm, the film typically has a reflectance of 55% or more, preferably 60% or more, more preferably 65% or more, such as when the film has a filling fraction of 40% and a thickness of 9 μm. In a fifth embodiment (large cellulose microparticle film) the film has a reflectance at 700 nm of 65% or more, such as when the film has a filling fraction of 40% and a thickness of 9 μm.

Typically, the film has a reflectance of 60% or more, preferably 70% or more, more preferably 73% or more for incoming light at a wavelength of from 400 to 800 nm, such as when the film has a filling fraction of 53% and a thickness of 9 μm.

In a sixth embodiment (large cellulose microparticle film) the film has a reflectance of 60% or more, preferably 70% or more, more preferably 73% or more for incoming light at a wavelength of from 400 to 800 nm, such as when the film has a filling fraction of 53% and a thickness of 9 μm.

In a sixth embodiment (large cellulose microparticle film) the film has an average reflectance over wavelengths of from 400 to 800 nm of 68% or more, preferably 73% or more, more preferably 78% or more for incoming light at a wavelength of from 400 to 800 nm, such as when the film has a filling fraction of 53% and a thickness of 9 μm.

At 500 nm, the film typically has a reflectance of 65% or more, preferably 70% or more, more preferably 75% or more, such as when the film has a filling fraction of 53% and a thickness of 9 μm. In a sixth embodiment (large cellulose microparticle film) the film has a reflectance at 500 nm of 75% or more, such as when the film has a filling fraction of 53% and a thickness of 9 μm.

At 600 nm, the film typically has a reflectance of 60% or more, preferably 70% or more, more preferably 75% or more, such as when the film has a filling fraction of 53% and a thickness of 9 μm. In a sixth embodiment (large cellulose microparticle film) the film has a reflectance at 600 nm of 75% or more, such as when the film has a filling fraction of 53% and a thickness of 9 μm.

At 700 nm, the film typically has a reflectance of 60% or more, preferably 65% or more, more preferably 70% or more, such as when the film has a filling fraction of 53% and a thickness of 9 μm. In a sixth embodiment (large cellulose microparticle film) the film has a reflectance at 700 nm of 70% or more, such as when the film has a filling fraction of 53% and a thickness of 9 μm.

In addition to high absolute reflectance values, the light reflected by the films is also highly diffuse. Thus, the light is typically reflected at a similar level across the given wavelength range. There are also no significant or sharp peaks in the reflectance spectra. This results in a film which has excellent whiteness, as particular coloured wavelengths are not dominant in the reflection or transmission spectra.

Typically, the film has an angular distribution of reflected light which follows a Lambertian profile or a Lambertian-like profile. A Lambertian reflectance profile is where the reflected light intensity observed from a reflecting surface is directly proportional to the cosine of the angle between the direction of the incident light and the surface normal. This is a desirable property for a white light scattering and is indicative of an ideal diffuser. This results in a material which has the same apparent brightness at all angles of observation.

Typically, the film has an angular distribution of reflected light which follows a Lambertian profile or a Lambertian-like profile, such as for a material having a thickness of 40 μm or less, such as 20 μm or less, such as 10 μm or less.

Whiteness can be quantified by converting the reflectance (measured as described herein) into CEILAB (L*a*b*) colour-space coordinates. Here, a* represent the position between red (positive values) and green (negative values, and b* represents the position between blue (negative values), and yellow (positive values). L* represents the perceptual lightness or luminosity of the reflection. A lightness of 0 is black and a lightness of 100 is diffuse white. A lightness close to 100 is indicative of excellent whiteness of a material.

For example, reflectance may be measured using a light source (Ocean Optics HPX-2000) coupled into an optical fiber (600 μm Thorlabs FC-UV100-2-SR) via a collimator (Thorlabs) and the signal collected by a spectrometer (Avantes HS2048), as shown in FIG. 8 (T₁ and T₂). The signal may be normalized with respect to the intensity when no sample was mounted. The background is typically recorded when no light is applied. The range of wavelengths may be between 400 and 800 nm. Five spectra may be taken for each sample and averaged to reduce the signal-to-noise ratio. Each spectrum may be recorded using an integration time equal to 3 s.

For quantification of whiteness, it may be assumed that perfect white has the colour space coordinate (100, 0, 0). Whiteness may be defined and calculated as set out in Jacucci et al.

Typically, the film has a lightness of 70 or more, preferably 75 or more, more preferably 80 or more, such as when the material has a filling fraction of 25% and a thickness of 25 μm. Typically, the film has a lightness of from 70 to 95, preferably from 75 to 90, more preferably 80 to 90 and even more preferably 85 to 90, such as when the material has a filling fraction of 25% and a thickness of 25 μm.

In a third embodiment (large cellulose microparticle film) the film has a lightness of 80 or more, preferably 85 or more, more preferably 88 or more, such as when the film has a filling fraction of 25% and a thickness of 25 μm.

In a fourth embodiment (medium cellulose microparticle film) the film has a lightness of 75 or more, preferably 80 or more, more preferably 82 or more, such as when the film has a filling fraction of 25% and a thickness of 25 μm.

Typically, the film has a lightness of 75 or more, preferably 80 or more, more preferably 83 or more, such as when the material has a filling fraction of 40% and a thickness of 9 μm. Typically, the film has a lightness of from 80 to 90, preferably from 82 to 86, such as 83 to 85, such as when the material has a filling fraction of 40% and a thickness of 9 μm. In a fifth embodiment (large cellulose microparticle film) the film has a lightness of 80 or more, preferably 85 or more, more preferably 88 or more, such as when the film has a filling fraction of 40% and a thickness of 9 μm.

Typically, the film has a lightness of 82 or more, such as 85 or more, such as 87 or more, such as when the material has a filling fraction of 53% and a thickness of 9 μm. Typically, the film may have a lightness of from 80 to 90, preferably from 83 to 89, more preferably 86 to 88, such as when the material has a filling fraction of 53% and a thickness of 9 μm. In a sixth embodiment (large cellulose microparticle film) the film has a lightness of 82 or more, preferably 85 or more, more preferably 87 or more, such as when the film has a filling fraction of 53% and a thickness of 9 μm.

The high luminosity of the present invention is indicative of excellent diffuse whiteness of the material.

The transmittance is the proportion of incident light which is transmitted through a material. A low transmittance is indicative of high opacity, arising from, for example, a high level of scattering of incident light and a high level of reflectance.

Transmittance may be measured in the same way as reflectance described above. The transmittance may equal (1−reflectance), where absorption is negligible.

Typically, the film has a transmittance of 20% or less, preferably 18% or less, more preferably 15% or less for incoming light at a wavelength of from 400 to 800 nm, such as when the material has a filling fraction of 40% and a thickness of 30 μm.

At 500 nm, the film typically has a transmittance of 12% or less, such as when the material has a filling fraction of 40% and a thickness of 30 μm. At 600 nm, the film typically has a transmittance of 13% or less, such as when the material has a filling fraction of 40% and a thickness of 30 μm. At 700 nm, the film typically has a transmittance of 14% or less, such as when the material has a filling fraction of 40% and a thickness of 30 μm.

Typically, the film has a transmittance of 25% or less, preferably 20% or less, more preferably 18% or less for incoming light at a wavelength of from 400 to 800 nm, such as when the material has a filling fraction of 40% and a thickness of 20 μm.

At 500 nm, the film typically has a transmittance of 15% or less, such as when the material has a filling fraction of 40% and a thickness of 20 μm. At 600 nm, the film typically has a transmittance of 17% or less, such as when the material has a filling fraction of 40% and a thickness of 20 μm. At 700 nm, the film typically has a transmittance of 18% or less, such as when the material has a filling fraction of 40% and a thickness of 20 μm.

Typically, the film has a transmittance of 35% or less, preferably 30% or less, more preferably 25% or less for incoming light at a wavelength of from 400 to 800 nm, such as when the material has a filling fraction of 40% and a thickness of 15 μm.

At 500 nm, the film typically has a transmittance of 22% or less, such as when the material has a filling fraction of 40% and a thickness of 15 μm. At 600 nm, the film typically has a transmittance of 25% or less, such as when the material has a filling fraction of 40% and a thickness of 15 μm. At 700 nm, the film typically has a transmittance of 25% or less, such as when the material has a filling fraction of 40% and a thickness of 15 μm.

Typically, the film has a transmittance of 45% or less, preferably 40% or less, more preferably 35% or less for incoming light at a wavelength of from 400 to 800 nm, such as when the material has a filling fraction of 40% and a thickness of 10 μm.

At 500 nm, the film typically has a transmittance of 30% or less, such as when the material has a filling fraction of 40% and a thickness of 10 μm. At 600 nm, the film typically has a transmittance of 32% or less, such as when the material has a filling fraction of 40% and a thickness of 10 μm. At 700 nm, the film typically has a transmittance of 35% or less, such as when the material has a filling fraction of 40% and a thickness of 10 μm.

The transmittance of the film is low. This is indicative of excellent scattering efficiency by the film, since only a small proportion of the incident light is transmitted through the film. The majority of the incident light is scattered and reflected, resulting in excellent whiteness.

The transport mean free path represents the average distance that light has to travel in the material before its initial propagation direction is randomized by interaction with the material. The transport mean free path is a measure of the scattering response of different materials independent of the sample structural parameters. The transport mean free path may be calculated from the transmittance of the material.

For example, the transport mean free path may be evaluated from the total transmission data by means of the following equation, as described in Syurik et al.:

$$T = \frac{2 {z}_{e} {l}_{t}}{L + 2 {z}_{e} {l}_{t}}$$

Where T, L, lₜ and zₑ are the total transmission, thickness, mean free path and extrapolation length, respectively. The extrapolation length takes into account internal reflections at the sample's interfaces on the evaluation of the mean free path and can be calculated by knowing the filling fraction system (Jacucci et al.).

Typically, the film has a mean free path of 10 μm or less, preferably 8 μm or less, more preferably 3 μm or less, such as when the film has a filling fraction of 25% and a thickness of 25 μm. In a third embodiment (large cellulose microparticle film) the film has a mean free path of 3 μm or less, such as when the film has a filling fraction of 25% and a thickness of 25 μm. In a fourth embodiment (medium cellulose microparticle film) the film has a mean free path 8 μm or less, such as when the film has a filling fraction of 25% and a thickness of 25 μm.

Typically, the film has a mean free path of 5 μm or less, such as 3 μm or less, such as 2 μm or less, when the film has a filling fraction of 40% and a thickness of 9 μm. In a fifth embodiment (large cellulose microparticle film) the film has a mean free path of 2 μm or less, such as when the film has a filling fraction of 40% and a thickness of 9 μm.

Typically, the film has a mean free path of 3 μm or less, preferably 2 μm or less, more preferably 1.5 μm or less, such as when the film has a filling fraction of 53% and a thickness of 9 μm. In a sixth embodiment (large cellulose microparticle film) the film has a mean free path of 1.5 μm or less, such as when the film has a filling fraction of 53% and a thickness of 9 μm.

Typically, the transport mean free path of the material is wavelength-independent, and generally resembles the shape of the total transmission spectra. This suggests excellent scattering efficiency by the material, affording excellent opacity and whiteness.

In some embodiments, the surface of the cellulose particles which comprise the film may be modified, as described above.

The film may be modified so that the film is hydrophobic. Typically, a hydrophobic film has a water droplet contact angle is over 90°, preferably over 100°, preferably over 110°, preferably over 120°, more preferably over 130°, such as around 140°. The hydrophobic film may comprise hydrophobic cellulose particles.

The hydrophobic film is particularly useful where antifouling and self-cleaning is desirable, such as in antifouling and self-clean coatings.

A hydrophobic film may be obtained from hydrophobic cellulose particles, such as cellulose particles in which a portion of the hydroxyl groups on the surface of the particles are replaced with hydrophobic groups, such as —OTMS or —O-trimethoxysilane. Surface modification of the cellulose particles may be as described above.

Without wishing to be bound by theory, it is thought that replacing a portion of the hydroxyl groups on the surface of the cellulose particles with —OTMS groups or —O-trimethoxysilane groups reduces the hydrogen bonding between the hydroxyl groups so the pores or voids between the cellulose particles are less prone to collapse under capillary pressure, for example, during solvent evaporation. This allows the films to be formed without the need for filtration and freeze-drying steps.

As a result, the films may be prepared using simplified and more easily scalable methods excluding, for example, freeze-drying steps. The films may also have an altered structure or filling fraction, hydrophobicity, strength or other physical property.

The film may also be divided into flakes, such as by fracturing the film. Typically, the flakes have a thickness which is the same as the film. The flakes typically have a length of between 5 μm and 500 μm, preferably 10 μm and 100 μm, preferably 20 μm to 70 μm. In general, a flake has a length and width which is greater than its thickness. The flake or flake-like shape typically has a uniform height over the majority of its length. The flake is typically flat in one dimension.

The optical properties of the flakes correspond to that seen for the films. The flakes may be dispersed in a suspension for use in compositions of the invention.

### Clusters

The invention also provides a cluster comprising the cellulose particles described herein.

The cluster may substantially consist of the cellulose particles as described herein. The cluster may consist of the cellulose particles as described herein.

The cluster may be an agglomeration of cellulose particles. Typically, the cellulose particles are held together by non-covalent interactions.

The cluster may be produced by the methods described herein. Accordingly, the invention provides a cluster obtained or obtainable by the methods of the invention.

The cluster is typically a sphere or sphere-like shape. The cluster generally has a high order of symmetry. The cluster may have a length, width and height which are similar or equal.

The cluster may have an aspect ratio of from 1 to 2, preferably from 1 to 1.5, more preferably from 1 to 1.2. The aspect ratio may be about 1.

Additionally, or alternatively, a population of the clusters may have a mean average aspect ratio of from 1 to 2, preferably from 1 to 1.5, more preferably from 1 to 1.2, wherein mean average aspect ratio is a ratio of the mean average length to the mean average width. Preferably the cluster has a mean average aspect ratio of about 1.

The cluster differs from the film or flake in that it is three dimensional, and is not flat in one dimension. That is, the cluster does not have a substantially planar morphology. The clusters are typically smaller than flakes (e.g. the length of a cluster is typically less than the length of a flake).

Preferably, the cluster has a length of (such as a dry length) which is from 1.0 μm to 100 μm, preferably from 2.0 μm to 50 μm, more preferably from 3.0 to 30.0 μm, even more preferably from 5.0 to 20.0 μm.

Additionally, or alternatively, a population of the clusters may have a mean average length of from 1.0 μm to 100 μm, preferably from 2.0 μm to 50 μm, more preferably from 5.0 to 20.0 μm.

The length of the cluster may be measured using standard techniques, such as by SEM.

In some embodiments, the cellulose particles are randomly distributed in the cluster.

Typically, the cluster includes pores or voids. The pores or voids are between the cellulose particles. The cluster may be said to be porous.

Typically, the shape of the pores is similar to the shape of the particles. The pores are generally elongate with a length dimension greater than the width dimension. The pores may have a similar width to the particles. The pores may have a similar length to the particles. The pores may have a similar aspect ratio to the particles.

The total volume of the pores equal to the total volume of a material (v₂) minus the volume of cellulose particles in the material (v₁).

The quantity of cellulose particles in the cluster can be estimated using the filling fraction (ff). The filling fraction (ff) is the ratio of the volume of cellulose particles in a material (v₁) to the total volume of the material (v₂).

The volume of cellulose particles in a cluster may be calculated using a nominal density ρ of 1.5 g/cm⁻³ for cellulose, where the volume of cellulose nanoparticles v₁=m/ρ (m is the weight of material). The volume of the material may be calculated by routine methods, based on measurements of the external dimensions of the cluster such as by measuring the diameter using SEM.

Alternatively, the filling fraction (ff) may be measured by comparison of the number and size of voids to other materials. For example, the number of voids present in a cluster can be compared to the number of voids present in a film comprising the same cellulose particles of a known filling fraction. The number and size of the voids may be established using standard techniques, such as by SEM. If the number and size of voids is similar for the cluster and the film, it can be said that the cluster has a similar filling fraction to that of the film. The filling fraction of the film is measured as described above.

The filling fraction is known to influence the optical properties of cellulose-based materials (for example, scattering efficiency and reflectance).

Typically, the cluster has a filling fraction of from 20 to 60%. Preferably the cluster has a filling fraction of from 25 to 55%, more preferably from 40 to 55%. Preferably the cluster has a filling fraction of about 50%.

The filling fraction and diameter of the cluster may be appropriately adjusted by adjusting the initial quantity of CMPs and the conditions of the spray-drying or spray-freeze drying process during cluster preparation (see below).

### Method of Preparing Cellulose Particles

Generally, the application provides a method of preparing a cellulose particle, the method comprising:
(a) adding acid to a cellulose material to hydrolyse the cellulose particles;
(b) removing the acid from the hydrolysed cellulose particles; and
(c) isolating a particular size of hydrolysed cellulose particles.

The step (a) of “Adding acid to the cellulose particles” may be referred to as the hydrolysing step. The step (b) of “removing acid from the hydrolysed cellulose particles” may be referred to as the washing step. The step (c) of “isolating a particular size of hydrolysed cellulose particles” may be referred to as the fractioning step.

The application also provides a method of preparing a cellulose particle, the method comprising:
(a) hydrolysing a cellulose material to provide hydrolysed cellulose particles;
(b) washing the hydrolysed cellulose particles; and
(c) fractioning a suspension of the hydrolysed cellulose particles.

The method is suitable for preparing the cellulose particles of the invention.

In some embodiments this method results in cellulose particles having a length of from 300 to 10,000 nm and an aspect ratio of from 2 to 20, preferably having a length of from 1,000 to 10,000 nm and an aspect ratio of from 2 to 18. Preferably the particles have a width of from 200 to 1,000 nm. Other sizes achievable by this method are as described above. The length and aspect ratio of the cellulose particle can be determined using any suitable method, as set out above.

The conditions used for hydrolysis step, washing step, and fractioning step can be adjusted to prepare a cellulose particle, having a length of from 300 to 10,000 nm and an aspect ratio of from 2 to 20, preferably having a length of from 1,000 to 10,000 nm and an aspect ratio of from 2 to 18. Preferably the particles have a width of from 200 to 1,000 nm.

This process does not require a solvent exchange step, which has previously been essential to produce porous scattering cellulosic materials.

Some processes of preparing cellulose particles are known. However, the processes described previously typically do not include a fractioning step and/or do not hydrolyse the cellulose material under the same conditions as the present invention. This results in cellulose particles having a different size and shape to the cellulose microparticles of the present invention (as described in the cellulose particle section).

US 2021/213405 describes a process including a hydrolysis and washing step. No fractioning step is described in US 2021/213405.

WO 2012/06720 describes a process for preparing cellulose nanowhiskers using a low concentration of sulfuric acid in a hydrolysis step. The document is also silent on a fractioning step.

CN 113152150 describes suspending CNCs, then filtering and drying the CNC suspension to form nanoparticles. The process does not include a hydrolysis step or a fractioning step.

CN 113174091 describes forming cellulose particles by acid hydrolysis. The acid concentration used is higher than 60 w/w % and a fractioning step is also not described.

CN 112280072 describes preparing cellulose particles from a suspension of CNCs with lactic acid and glucose, which is then dried to form a film. The process does not include a hydrolysis step, a washing step or a fractioning step.

CN 113480756 describes preparing cellulose films by acid hydrolysis with 64 wt. % sulfuric acid at 45° C. The document does not describe fractioning the suspension of hydrolysed cellulose particles. The resulting film is coloured.

EP 3854819 relates to a method of hydrolysing cellulose with 64 wt. % sulfuric acid at various temperatures. The hydrolysed solution is washed and dialysed. A fractionation process using differential centrifugation is not described.

CN 106699904 describes preparation by hydrolysis with hydrochloric acid. The document also does not describe a fractioning step.

US 2013/303750 describes a method of hydrolysing cellulose before washing and dialysis. The hydrolysis step uses different conditions to the preferred embodiment of the present invention. A hydrolysis step using 50 v/v % of acid, a temperature of 50° C. and a time of 3-5 hours is not disclosed. The document also does not describe a fractioning step using differential centrifugation. The raw material used in US 2013/303750 is a bleached Eucalyptus dry lab pulp, opposed to the preferred microcrystalline cellulose powder of the present invention.

CN 113150319 describes preparation of cellulose nanocrystals by hydrolysis at from 30 to 80° C. with from 10 to 80% sulfuric acid. The present invention represents a new selection of temperature and sulfuric acid concentration of to provide the CMPs. The document does not describe a washing step or fractioning step in the preparation method.

CN 102276734 describes a process of hydrolysing cellulose pulp with 35 wt. % sulfuric acid solution at 60° C. for 5 hours. The hydrolysed cellulose is washed, dried and then re-dispersed using an ultrasonic bath. The acid concentration is lower in the present invention and a fractioning step is not described.

The method of preparing a cellulose particle may also comprise:
providing a cellulose material.
   This may be known as a preparation step, and refers to making a suitable cellulose material available. The preparation step typically takes place before the hydrolysis step.

Any suitable cellulose material may be used. Suitable cellulose material may be prepared from bacterial, vegetal or animal sources (e.g. chitin), including plant-based and biomass source such as cotton and wood along with subsequent processed products such as paper, filter-paper cotton linters, cellulose powder and wood pulp.

Preferably, the cellulose material is a microcrystalline cellulose powder. Suitable microcrystalline cellulose powder is commercially available (e.g. from SERVA Electrophoresis GmbH) The cellulose material may be provided in the form of a suspension. Preferably a microcrystalline cellulose powder is dispersed in water to form an aqueous suspension.

A suspension is a heterogeneous mixture of a fluid that contains solid particles that are typically sufficiently large for sedimentation to occur if the suspension is left undisturbed for extended periods of time. The cellulose particles are suspended in the liquid. The suspension may be mixed, for example by sonification, to avoid settling of the cellulose particles.

Any suspension medium suitable for holding cellulose material may be used. Suitable suspension media are typically aqueous solvents, such as water. Acidic and basic media may be used. Typically, acid is used, and suitable acids are set out below.

The method of preparing a cellulose particle comprises:
hydrolysing a cellulose material to provide hydrolysed cellulose particles.
   This may be known as the hydrolysis step. The hydrolysis step takes place before the washing step.

The hydrolysis is typically carried out in aqueous solvent (e.g. water).

In the hydrolysis step, the cellulose material is typically hydrolysed with an acid. Acid hydrolysis is a hydrolysis process in which a protic acid is used to catalyse the cleavage of a chemical bond via a substitution reaction with the addition of water. During acid hydrolysis, it is also proposed that the cellulose chain backbone of the cellulose particle is modified at the molecular level to provide colloidal stability to the cellulose particle. For example, sulfuric acid hydrolysis is thought to modify the cellulose chains with sulfate half ester groups.

The hydrolysis step may comprise contacting the cellulose material, such as the suspension of cellulose material, with acid.

The acid may be an organic acid or an inorganic acid. Typically, the acid is an inorganic acid (a mineral acid). Suitable inorganic acids include hydrobromic acid (HBr), hydrochloric acid (HCl), hydrofluoric acid (HF), hydroiodic acid (HI), nitric acid (HNO₃), perchloric acid (HClO₄), phosphoric acid (H₃PO₄), sulfuric acid (H₂SO₄) or a combination thereof. Preferably the inorganic acid is sulfuric acid or hydrochloric acid. More preferably the inorganic acid is sulfuric acid.

Suitable organic acids include formic acid (HCOOH) and acetic acid (CH₃OOOH). Preferably the organic acid is formic acid.

Preferably the acid is sulfuric acid or hydrochloric acid. More preferably the acid is sulfuric acid.

The strength of an (aqueous) acid can be specified using the pH scale. Methods for determining the pH of an aqueous solution are known and include, for example, electrochemical methods (using a pH probe) and titration against an indicator compound such as universal indicator. Typically, the pH refers to the pH of the hydrolysis solution at the end of the hydrolysis step.

The acid used in the hydrolysis step is highly acidic. Typically, the acid has a pH of 1.0 or lower, preferably, 0.5 or lower, more preferably or 0.0 or lower.

The strength of the acid is proportional to the concentration of the acid. The concentration of an aqueous acid can be specified using volume percentage (v/v %).

Typically, the concentration of the acid is from 40 to 60 v/v %, preferably from 45 to 55 v/v %, more preferably from 50 to 55 v/v %. The v/v % is typically calculated with water as the solvent.

The amount of acid is selected to allow a desirable quantity of cellulose material to be suspended. The amount of aqueous acid can be specified by stating the volume aqueous acid in mL per gram of cellulose material used (the ratio of acid to cellulose material).

Typically, the hydrolysis step uses a mass ratio of acid to cellulose material of 100:1 preferably 80:1, more preferably 60:1. In addition or alternatively, the hydrolysis step may use a mass ratio of acid to cellulose material of 4:1, preferably 10:1. For example, the hydrolysis step may use a mass ratio of acid to cellulose material of from 100:1 to 4:1, preferably from 80:1 to 10:1. A higher ratio of cellulose to acid make the process more efficient as less acid is required for the hydrolysis step and less solvent is required for the washing step.

The hydrolysis step may be performed for a sufficient time to allow a desirable quantity of cellulose material to be hydrolysed. Typically, the hydrolysis is performed for from 1 to 10 hours, preferably from 2 to 8 hours, more preferably from 3 to 7 hours, such as about 5 hours.

The hydrolysis takes place from the addition of the acid until the reaction is quenched. The reaction may be quenched by any suitable means, such as by adding water to dilute the acid, adding base to neutralise the acid, removing the acid (e.g. by washing such as by dialysis), or reducing the temperature.

The hydrolysis step may be performed at elevated temperature (above ambient temperature; approximately 20° C.). Methods for providing heat during the hydrolysis step are known and include, for example, using a reaction vessel having an external heating jacket or using microwave heating.

Typically, the hydrolysis step is performed at a temperature of from 40 to 60° C., preferably from 45 to 55° C., more preferably from 48 to 52° C., such as about 50° C.

Preferably, the cellulose material is hydrolysed with 50 v/v % sulfuric acid at a temperature of about 50° C. for 3 to 5 hours.

In some embodiments, in step (b) the cellulose material is hydrolysed with 50 v/v % sulfuric acid 5 hours at a temperature of 50° C. In some embodiments, in step (b) the cellulose material is hydrolysed with 55 v/v % sulfuric acid 5 hours at a temperature of 60° C.

The hydrolysis may be stopped by quenching the acid hydrolysis. Typically, the hydrolysis is quenched by the addition of water, such as an excess of water. For example, if 60 mL of sulfuric acid is used to hydrolyse cellulose particles, then 300 mL of water may be added to quench the acid hydrolysis.

It is thought that using a higher concentration of acid, a higher temperature or a longer time period increases the rate of acid hydrolysis. Typically, a greater degree of hydrolysis results in a smaller cellulose particle size.

The hydrolysed cellulose particles may be collected by any suitable method. Typically, the hydrolysed cellulose particles are collected by centrifugation. Centrifugation can separate the hydrolysed cellulose particles from the acid supernatant, and optionally the water added to quench the acid hydrolysis. The supernatant can then be removed, for example using a pipette.

The method of preparing a cellulose particle comprises:
washing the hydrolysed cellulose particles.
   This may be known as the washing step. The washing step takes place after the hydrolysis step and before the fractionation step.

The hydrolysed cellulose particles may be washed by adding water. The water may then be removed. Thus, the washing step may comprise contacting the hydrolysed cellulose particles with water.

The washing step typically quenches the hydrolysis reaction, and so ends the hydrolysis step. The washing step may dilute the acid from the cellulose particles, thus quenching the hydrolysis reaction.

Typically, the washing step may add sufficient water to provide a concentration of 1 wt. % of cellulose particles. For example, for 1 g of hydrolysed cellulose particles, around 100 mL of water may be added per wash. This may be repeated one or more times, preferably two or more times, more preferably three or more times to remove the acid. The washing water may then be removed by centrifugation.

Preferably, the washing step may alternatively or additionally comprise dialyzing the hydrolysed cellulose particles with water, such as distilled water. The dialysis may take place after washing with water as set out above. Dialysis comprises resuspending the hydrolysed cellulose particles in distilled water and purifying them from dissolved ions (e.g. the acid used in the hydrolysis step) by means of their unequal rates of diffusion through the pores of semipermeable (dialysis) membrane. Any suitable dialysis membrane may be used. Suitable dialysis membranes have molecular weight cut off of 12 kDa or more, such as from 12 to 40 kDa.

The distilled water may be replaced during the dialysis process. For example, the distilled water may be replaced every 12 hours during dialysis. The distilled water may be replaced 5 or more times, preferably 10 or more times.

In some embodiments, the hydrolysed cellulose material is dialyzed against distilled water for 7 days, replacing the distilled water every 12 hours.

In some embodiments, the hydrolysed cellulose material is dialyzed until the pH of the hydrolysed cellulose material has stabilized. The pH may be measured each time the distilled water is replaced during the dialysis process, such as every 12 hours. Typically, the pH of the hydrolysed cellulose material has stabilized once the pH is constant for at least two consecutive measurements, preferably four consecutive measurements, more preferably six consecutive measurements. Alternatively, the pH may be measured once per day, and the pH has stabilized once the pH is constant for at least two consecutive days, preferably three consecutive days, more preferably four consecutive days.

The constant pH indicates that the acid or base has been substantially removed from the hydrolysed cellulose material. Methods for determining the pH of an aqueous solution are known, as set out above.

In some embodiments, the washing step may comprise removing the acid from the cellulose particles by centrifugation, washing with water and removing the water by centrifugation, and dialyzing the hydrolysed cellulose material.

The method of preparing a cellulose particle comprises:
fractioning a suspension of the hydrolysed cellulose particles.
   This may be known as the fractionation step. The fractionation step takes place after the washing step.

The hydrolysed cellulose particles may be fractioned by any suitable method. Suitable methods include filtration and centrifugation. Preferably the hydrolysed cellulose particles are separated from the liquid by differential centrifugation.

The fractioning takes place on a suspension of the hydrolysed cellulose particles. For the fractioning step, the suspension of hydrolysed cellulose particles is typically a suspension of individual cellulose particles. That is, the hydrolysed cellulose particles are not significantly aggregated, or aggregated, in the suspension of hydrolysed cellulose particles. This is beneficial, since it avoids the fractioning step removing aggregations of cellulose particles having the desired size and shape. This improves the yield of cellulose particles having the desired size and shape.

The fractioning (such as centrifugation) is carried out on a suspension of the cellulose particles. Typically, a suspension of the cellulose particles in water, such as Millipore water, is used. Any suitable concentration may be used. Suitable concentrations comprise from 0.1 wt % to 5.0 wt % cellulose particles, such as 0.2 wt % to 2.0 wt %, such as 0.2 wt % to 1.0 wt %. Preferably, the concentration of hydrolysed cellulose particles is 0.5 wt %.

The suspension of the cellulose particles may be prepared by any suitable method. The hydrolysed cellulose particles may be mixed or agitated prior to separation. Typically, the hydrolysed cellulose particles are sonicated prior to separation, such as by tip sonication or ultrasonification.

In some embodiments, a 30 ml suspension with 0.5 wt % particle concentration of the hydrolysed cellulose particles is ultrasonicated at an Amplitude of 30% for 2 min in 2s on 2s off cycles. Ultrasonification may be performed using any suitable apparatus, such as a Fisherbrand Ultrasonic disintegrator, 20 kHz, tip diameter 12.7 mm.

Typically, the differential centrifugation comprises a first centrifugation and a second centrifugation. The first centrifugation is at a different speed than the second centrifugation. The first centrifugation is at a lower speed than the second centrifugation. The second centrifugation is typically carried out on the supernatant from the first centrifugation.

The first centrifugation may be at a speed of from 1,000 to 3,000 rpm, preferably from 1,500 to 2500 rpm, more preferably from 1,800 to 2200 rpm, such as around 2,000 rpm.

The second centrifugation may be at a speed of from 2,000 to 4,000 rpm, preferably from 2500 to 3500 rpm, more preferably from 2,800 to 3,200 rpm, such as around 3,000 rpm.

Centrifugation speed may also be quantified using relative centrifugal force (RCF). RCF is a measure of the force acting on the particles during centrifugation. RCF is generally expressed as multiples of the earth's gravitational field (g). RCF may be calculated by the following equation, where radius (cm) is the distance from the centre of the centrifuge to the extremity of the sample and rotation speed (rotation per minute) is the rotation speed of the centrifuge. The radius is typically about 15 cm.

$$RCF = 11.2 \times radius \times {( rotation speed / 1000 )}^{2} .$$

The RCF of the first centrifugation may be different to the second centrifugation. The RCF of the first centrifugation may be less than the second centrifugation.

The first centrifugation may be at a RCF of from 50 to 1,500, preferably 150 to 1,500, more preferably from 300 to 1,100, yet more preferably from 500 to 900, even more preferably from 600 to 800. The first centrifugation may be at a RCF of about 650.

The second centrifugation may be at a RCF of from 600 to 2,600, preferably from 1,000 to 2,000, more preferably from 1,300 to 1,700, yet more preferably from 1,400 to 1,600. The second centrifugation may be at a RCF of about 1,500.

The first centrifugation may be at a RCF of from 168 to 1,512, preferably from 378 to 1,150, more preferably from 544 to 813. The first centrifugation may be at a RCF of about 672.

The second centrifugation may be at a RCF of from 671 to 2,688, preferably from 1,050 to 3,058, more preferably from 1,317 to 1,720. The second centrifugation may be at a RCF of about 1,512.

The first centrifugation may be carried out for a time of from 1 to 20 minutes, preferably from 2 to 15 minutes, preferably from 3 to 10 minutes, more preferably from 4 to 6 minutes, such as around 5 minutes.

The second centrifugation may be carried out for a time of from 1 to 20 minutes, preferably from 2 to 15 minutes, preferably from 3 to 10 minutes, more preferably from 4 to 6 minutes, such as around 5 minutes.

Preferably the first centrifugation is carried out at 2000 rpm for five minutes and the second centrifugation is carried out at 3000 rpm for five minutes, and the second centrifugation is carried out on the supernatant from the first centrifugation.

It is thought that a two-step differential centrifuging process results in a narrower particle size distribution for the cellulose particles. The first centrifugation at a lower speed sediments the larger cellulose particles. The supernatant from the first centrifugation thus still includes the desired size particles and smaller particles. This supernatant from the first centrifugation is then centrifuged again at a high speed so as to sediment the desired particles. The smaller particles remain in the supernatant from the second centrifugation. As a result, the sedimented particles from the second centrifugation do not include a large proportion of larger or smaller particles, so the particle size distribution is narrower.

The sedimented cellulose particles may be collected by any suitable method. Typically, the cellulose particles are collected by filtration.

The cellulose particles are typically collected as a slurry or a suspension. The slurry or suspension may be with water, ethanol or acetone. Preferably, the slurry or suspension is with water.

The sedimented larger cellulose particles from the sediment fraction of the first centrifugation may be recirculated and reprocessed by repeating the sonication and fractionation steps described above. This may improve the yield of the fraction containing the desired particle sizes.

The method of preparing a cellulose particle may also comprise:
drying the fractionated cellulose particles.
   This may be known as the drying step. The drying step typically takes place after the fractionation step. The drying step is typically carried out on the slurry or suspension of cellulose particles prepared by the fractionation step.

Typically, the drying step comprises removing a solvent from the fractionated cellulose particles. The drying step typically comprises removing water, ethanol or acetone from the fractionated cellulose particles. Preferably, the drying step comprises removing water from the fractionated cellulose particles.

The fractionated cellulose particles may be dried by any suitable method. Suitable methods include evaporation, freeze-drying, spray-drying or spray-freeze drying. Preferably, the method is freeze-drying, spray-drying or spray-freeze drying. More preferably, the method is freeze-drying.

Any suitable freeze-drying apparatus may be used. Suitable freeze-drying apparatus include Scanvac and Coolsafe freeze driers by LaboGene A/S, or VirTis freeze dryer by SP Scientific.

Any suitable spray-drying apparatus may be used. Suitable spray-drying apparatus include a PrecisionCoat spray coater by Specialty Coating Systems (SCS).

Any suitable spray-freeze drying apparatus may be used. Suitable spray-freeze drying apparatus include a PrecisionCoat spray coater by SCS and Scanvac and Coolsafe freeze driers by LaboGene A/S.

Typically, the drying step provides a dry powder of cellulose particles. Freeze drying or spray-drying may provide a dry powder of cellulose particles. Preferably, freeze drying provides a dry powder of cellulose particles.

The drying step may provide clusters of cellulose particles. Preferably, spray drying or spray-freeze drying provides clusters of cellulose particles.

The shape and size of the dried cellulose particles are generally the same as the cellulose particles before drying.

The dry powder of cellulose particles is useful for many applications. Several applications require the cellulose particles to be provided as a dry powder, such that the cellulose particles can be redispersed in different media.

The dry powder also minimizes storage and transportation cost due to a reduced mass of solvent. The dry powder also inhibits fungal and bacterial growth in the cellulose particles.

The dry powder further allows the cellulose particles to be redispersed in a different polarity solvent to that used for the preparation of the cellulose particles. For example, if the cellulose particles are prepared in a polar solvent (e.g. water), the dry powder can be redispersed in a non-polar solvent (e.g. organic solvent). The dry powder may also undergo further chemical modifications. The dry powder may be redispersed in an organic solvent prior to further chemical modifications.

Optionally, the method of preparing cellulose particles may further comprise:
modifying the surface of the cellulose particles.
   This may be known as the surface modification step. Typically, the surface modification step is carried out after fractionation of the cellulose particles.

The surface modification may be carried out on any cellulose particles. Typically, the surface modification is carried out on the cellulose particles obtained in the fractionation step or the drying step described above.

The surface modification step typically comprises transforming a hydroxyl group on the surface of the cellulose particle into a different functional group. The hydroxyl group is preferably converted into an ester (esterification) or an ether (etherification). Preferably the hydroxyl groups are converted into an ether group, such as a silylether group.

In some embodiments, the surface modification step comprises contacting the cellulose particles with an esterification agent or an etherification agent. Preferably, the surface modification step comprises contacting the cellulose particles with a hydrophobic agent.

Any suitable reagent may be used to perform the surface modification. Preferably, the reagent is an esterification reagent or an etherification reagent. Preferably, the surface modification step involves treating the cellulose particle with anhydrite, acyl chloride or epoxy bearing reagents. The hydrophobic agent includes any suitable hydrophobic agent, such as trimethylchlorosilane (TCMS) and chlorotrimethoxysilane. Preferably the hydrophobic agent is TCMS.

The reagent may be liquid or a vapour (gas). Typically, the reagent agent is a vapour.

The surface modification may be carried out in a solution or in a gas phase reaction. The solution may be an aqueous solution or a non-aqueous solution. The surface modification may be carried out under an inert atmosphere, such as a nitrogen or an argon atmosphere.

The hydroxyl groups on the surface of the cellulose particle may be activated before the surface modification reaction. Any suitable activator may be used. Preferably the activator is a basic solution, preferably a sodium hydroxide solution.

The surface modification may be carried out in the presence of a catalyst. Any suitable catalyst may be used. Preferably the catalyst is a basic catalyst. Preferably the catalyst is pyridine, 4-dimethylaminopyridine or trimethylamine.

The surface modification step may be carried out for any suitable length of time. Typically, the surface modification step is carried out 5 minutes or less, such as 3 minutes or less, such as 2 minutes or less, such as 1 minute or less.

The surface modification step provides surface modified cellulose particle. Without wishing to be bound by theory, it is thought that modifying the hydroxyl groups on the surface of the cellulose particles, such as with an ester or an ether alters the hydrogen bonding between the surfaces of the cellulose particles. The modification may increase or decrease the hydrogen bonding. Preferably the modification reduces the hydrogen bonding between the hydroxyl groups so the pores or voids between the cellulose particles are less prone to collapse under capillary pressure, for example, during solvent evaporation.

The surface modification with a hydrophobic agent provides hydrophobic cellulose particles. It is thought that replacing a portion of the hydroxyl groups on the surface of the cellulose particles with a hydrophobic group (such as —OTMS) reduces the hydrogen bonding between the hydroxyl groups so the pores or voids between the cellulose particles are less prone to collapse under capillary pressure, for example, during solvent evaporation. The dispersibility of the particles in solution is also able to be customised, for example to increase dispersibility in non-polar solvents.

### Method of Preparing Films

In general, the application also provides a method of preparing a film comprising cellulose particles, the method comprising:
(a) providing a suspension of cellulose particles;
(b) filtering the suspension to provide a wet film of cellulose particles; and
(c) freeze drying the wet film of cellulose particles.

The method for preparing a film comprises providing a suspension of cellulose particles. This may be known as the preparation step.

Any cellulose particles may be used in the preparation step (hydrophobic, surface modified or normal). Preferably, the cellulose particles of the invention (as set out above) are used.

The suspension of cellulose particles may be provided directly from the fractionation step. The suspension of cellulose particles may be provided by re-dispersing dried cellulose particles from the drying step.

The concentration of the cellulose particles in the suspension may be adjusted to change the filling fraction and thickness of the material produced.

The concentration is typically from 0.1 to 12 wt. %, preferably 4 to 10 wt. %, more preferably 6 to 8 wt. %.

Any suitable solvent may be used to prepare the suspension. Suitable solvents include water, ethanol and acetone.

Preferably the solvent is water, ethanol or acetone. More preferably the solvent is water.

The method for preparing a film comprises filtering the suspension to provide a wet film of cellulose particles. This may be known as the filtering step.

The filtering step may comprise filtering the suspension through a hydrophilic membrane, such as a polyvinylidene fluoride membrane. Typically, the filtering is carried out under vacuum. The duration of the filtering process and strength of the vacuum may be used to adjust the filling fraction and thickness of the material produced.

Typically, the suspension of cellulose microparticles is vacuum filtrated until a wet film with no visible solvent layer is formed. The wet film may be subjected to vacuum on the filter for an additional time period to adjust the thickness of the film.

In some embodiments, vacuum filtration is carried out using a vacuum pump at a pressure of 600-700 mbar. The vacuum filtration is carried out for from 5 to 60 minutes.

Without wishing to be bound by theory, it is thought that filtering draws the solvent through the material, thereby creating pores or voids in the material. When the solvent is removed, pores or voids are left in the material resulting in an interconnected (percolated) network of cellulose particles. Typically, the cellulose particles are randomly orientated in the material.

The method for preparing a film comprises freeze drying the wet film of cellulose particles. This may be known as the freeze-dying step.

The freeze-drying step may be carried out by freeze-drying both the filter and wet film deposited on the filter. The filter provides temporary structural support to the delicate wet film. This avoids the need to move the delicate wet film alone.

Typically, the freeze drying is carried out by transferring the filter and the wet film into liquid nitrogen. Once the wet film is frozen, it can be removed from the filter. This provides a free-standing material, such as a free-standing film separate from the filter.

Any suitable freeze-drying apparatus may be used. Suitable freeze-drying apparatus in include Scanvac and Coolsafe freeze driers by LaboGene A/S, or VirTis freeze dryer by SP Scientific.

This method provides a film of CMPs (described above).

Following freeze-drying, the film may be divided into particles, such as by cutting, blending or grinding the material or film.

The film may also be divided into flakes, such as by fracturing the film. Typically, the flakes have a thickness which is the same as the film. The flakes typically have a length of between 5 μm and 500 μm, preferably 10 μm and 100 μm, preferably 20 μm to 70 μm. In general, a flake has a length and width which is greater than its thickness. The flake or flake-like shape typically has a uniform height over the majority of its length.

### Method of Preparing Clusters

A method of preparing a cluster comprising cellulose particles, the method comprising:
(a) providing a suspension of cellulose particles; and
(b) spray-drying the suspension of cellulose particles.

The method for preparing a cluster comprises providing a suspension of cellulose particles. This may be known as the preparation step.

Any cellulose particles may be used in the preparation step (hydrophobic, surface modified or non-modified). Preferably, the cellulose particles of the invention (as set out above) are used.

The suspension of cellulose particles may be provided directly from the fractionation step. The suspension of cellulose particles may be provided by re-dispersing dried cellulose particles from the drying step.

The concentration of the cellulose particles in the suspension may be adjusted to change the filling fraction and size of the cluster produced.

The concentration is typically from 0.001 to 1 wt. %, preferably 0.05 to 0.1 wt. %, more preferably 0.005 to 0.05 wt. %. For example, the concentration may be about 0.01 wt. %.

Any suitable solvent may be used to prepare the suspension. Suitable solvents include water, ethanol and acetone.

Preferably the solvent is water or ethanol. More preferably the solvent is water.

The method for preparing a cluster comprises spray drying or spray-freeze drying the suspension of cellulose particles. This may be known as the spray-dying step.

Typically, the spay drying is carried out by spraying the CMP suspension with a gas. The CMP suspension may be atomised using an atomiser to provide small droplets of CMP suspension. A gas may be mixed with the CMP suspension before atomisation to assist with atomisation and/or the gas may be mixed with the atomised CMP suspension. The gas typically evaporates the solvent from the CMP suspension. This provides a dry cluster of cellulose particles. The gas may be provided at elevated temperature (above ambient temperature; approximately 20° C.).

The atomiser may be tuned to adjust the size of the droplets of CMP suspension. The size of the droplets may be used to control the size of the CMP cluster.

The gas may be provided at elevated temperature (above ambient temperature; approximately 20° C.). The temperature of the gas may be adjusted to change the rate of evaporation. Typically, a gas having a temperature of between 6° and 90° C., preferably between 7° and 80° C. is used.

Any suitable spray-drying apparatus may be used. Suitable spray-drying apparatus include a PrecisionCoat spray coater by Specialty Coating Systems (SCS).

Any suitable spray-freeze drying apparatus may be used. Suitable spray-freeze drying apparatus include a PrecisionCoat spray coater by SCS (spray drying) and Scanvac and Coolsafe freeze driers by LaboGene A/S, or VirTis freeze dryer by SP Scientific (freeze drying).

For spray-freeze drying, the suspension is spray dried directly into liquid nitrogen. The frozen clusters are then collected from the liquid nitrogen and freeze dried.

This method provides a cluster of CMPs (described above).

Following the spray-drying step, the cluster may be divided into smaller clusters, such as by cutting, blending or grinding the cluster.

### Drop-Casting Preparation of Hydrophobic Films

As noted above, the cellulose particles of the present invention may be treated with a hydrophobic agent to provide a hydrophobic material. Without wishing to be bound by theory, it is thought that replacing a portion of the hydroxyl groups on the surface of the cellulose particles with hydrophobic groups (such as —OTMS groups or O—Si(OMe)₃ groups) reduces the hydrogen bonding between the hydroxyl groups so the pores or voids between the cellulose particles are less prone to collapse under capillary pressure, for example, during solvent evaporation. Accordingly, the application also provides a method of preparing a hydrophobic cellulose film, the method comprising:
(a) providing a suspension of hydrophobic cellulose particles; and
(b) drop-casting the suspension.

The method for preparing a hydrophobic cellulose film comprises providing a suspension of hydrophobic cellulose particles. This may be known as the preparation step.

Any hydrophobic cellulose particles may be used in the preparation step. Preferably, the hydrophobic cellulose particles of the invention (as set out above) are used.

The suspension of cellulose particles may be provided directly from the fractionation step. The suspension of cellulose particles may be provided by re-dispersing dried cellulose particles from the drying step.

Any suitable solvent may be used to prepare the suspension. Suitable solvents include water and ethanol, acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethylene glycol, diethyl ether, diglyme (diethylene glycol, dimethyl ether), 1,2-dimethoxy-, ethane (glyme, DME), dimethyl-, formamide (DMF), dimethyl sulfoxide (DMSO), 1,4-dioxane, ethanol, ethyl acetate, ethylene glycol, glycerin, heptane, hexamethylphosphoramide, (HMPA), hexamethylphosphorous, triamide (HMPT), hexane, methanol, methyl t-butyl, ether (MTBE), methylene chloride, N-methyl-2-pyrrolidinone, (NMP), nitromethane, pentane, petroleum ether (ligroine), 1-propanol, 2-propanol, pyridine, tetrahydrofuran (THF), toluene, triethyl amine, o-xylene, m-xylene, p-xylene or ionic liquids.

Preferably, a volatile solvent is used. More preferably, the solvent is ethanol or acetone. Yet more preferably the solvent is ethanol.

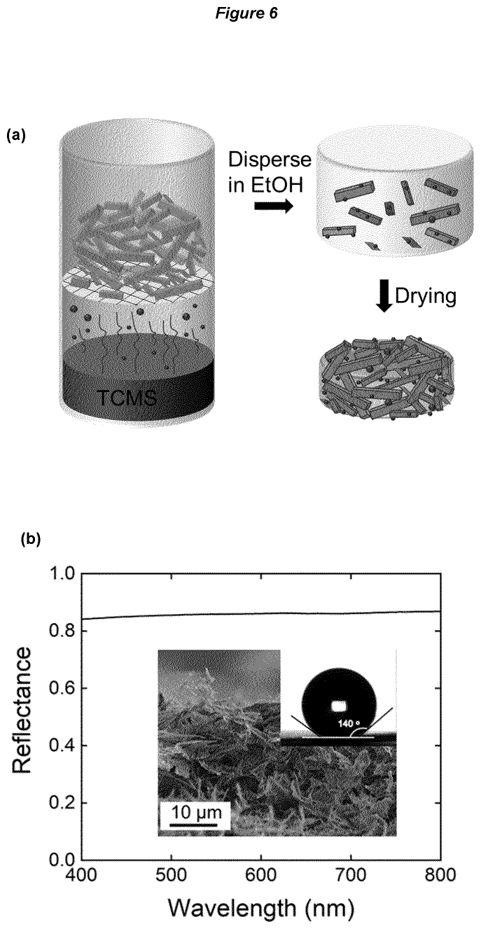

The method for preparing a hydrophobic cellulose film comprises drop casting the suspension of hydrophobic cellulose particles. This may be known as the drop-casting step. An embodiment of this method is illustrated in FIG. 6a.

The drop-casting step typically comprises:
contacting the suspension of hydrophobic cellulose particles with a casting surface; and
evaporating the solvent.

Any suitable casting surface may be used. Suitable casting surfaces include glass and polymers such as PTFE.

The solvent may be allowed to evaporate at room temperature. Alternatively, the casting surface may be heated to encourage evaporation of the solvent.

The drop-casting may occur by casting the suspension in air. Typically, the drop cast suspension is then left to dry in air at room temperature to form the film.

This drop-casting process avoids the need for the filtration and freeze-drying steps. As a result, the method of forming the material is simplified and more easily scalable.

It is thought that, when treated with TCMS, part of the hydroxyl groups on the surface of CMPs are replaced by —O—SiCH₃ moieties, so the hydrogen bonding between hydroxyl groups is significantly reduced during the drying process. Without wishing to be bound by theory, due to the reduced hydrogen bonding and the lower surface tension of ethanol with respect to water, a porous network of cellulose particles can be achieved, in particular a thin film of cellulose particles, without collapsing under the capillary pressure produced by the solvent evaporation.

### Compositions

The cellulose particles of the invention are suitable as pigments, whiteness enhancers, scattering enhancers and opacifiers.

The cellulose particles may be included in a composition in any form described above.

In some embodiments the cellulose particles used in a composition are those obtained directly from the fractionation step or obtained directly from the drying step.

In some embodiments the cellulose particles used in a composition are flakes obtained from a film of the cellulose particles, such as by dividing the film (as set out above)

In some embodiments the cellulose particles used in a composition are clusters of cellulose particles obtained by drying, such as by spray drying or spray-freeze drying, the cellulose particles (described above).

In some embodiments the cellulose particles used in a composition is a powder of cellulose particles obtained by drying, such as by freeze drying or spray-drying, the cellulose particles (described above).

In some embodiments the cellulose particles used are surface modified cellulose particles, such as cellulose particles treated with a hydrophobic agent or cellulose particles undergone surface modification. The surface modification may be modification of a hydroxyl group to an ester or an ether group, such as a TMS group.

The cellulose particles of any of the forms described above may be redispersed in a solvent, to provide a suspension of cellulose particles. Preferably, the powder of dried cellulose particles is redispersed in a solvent to provide a suspension of cellulose particles. The resulting suspension of cellulose particles may be used in a composition.

The redispersing solvent is any suitable solvent including water, ethanol or acetone. Preferably the solvent is water or ethanol. More preferably the solvent is water.

The pH of the redispersed suspension may be adjusted. The pH may be adjusted by any suitable method. Typically, the pH is adjusted by the addition of a suitable acid or base to the aqueous cellulose suspension. Suitable acids include H₂SO₄ and HCl. Suitable bases include NaOH and KOH. pH can be measured using any suitable method, as described above.

Typically, the pH is adjusted to a pH of from 6.0 to 8.0, preferably from 6.5 to 7.5, more preferably from 6.8 to 7.2, even more preferably from 6.9 to 7.1. The pH may be adjusted to a pH of about 7.0.

It is thought that adjusting the pH of the suspension results in greater dispersibility of the particles in the suspension. This in turn results in greater dispersibility of the particles in the composition in which the suspension is formulated.

Without wishing to be bound by theory, it is thought that adjusting the pH in this way weakens the hydrogen bonding between the cellulose particles, thus improving the dispersibility of the particles. For example, by adding a suitable base (such as NaOH and KOH) the acidic hydrogens of the cellulose particles are replaced by monovalent cations form the base (such as Na⁺ and K⁺). This is thought to improve the dispersibility of the dried cellulose powder in a polar solvent, such as water. This procedure yields cellulose particles which are stable in water without the need for extra additives or stabilisers.

The redispersed suspension of cellulose particles may also be mechanically agitated. Preferably, mechanical agitation follows a step of adjusting the pH of the cellulose suspension. Mechanical agitation includes any suitable method, such as stirring, sonication or ultrasonication. Preferably, the mechanical agitation is ultrasonication. The mechanical agitation is sufficient to obtain fully dispersed suspension of the cellulose particles. STEM images may be used as an indication of the suspension quality.

It is thought that mechanically agitating the suspension results in greater dispersibility of the particles in the suspension.

Preferably, the cellulose particles (such as dried cellulose particles) are redispersed in a solvent to provide a suspension of cellulose particles, and the suspension is pH adjusted and mechanically agitated. The resulting suspension of cellulose particles is then used in a composition.

The invention also provides a composition comprising the cellulose particles of the invention. The excellent biocompatibility of the cellulose particles makes them particularly suitable for use in consumables, such as foods, personal care products or pharmaceuticals.

In some embodiments, there is provided a food comprising the cellulose particles of the invention. Suitable foods include those which benefit from enhanced whiteness or enhanced opacity. Suitable foods include sauce, gravy, chicken, bread, artificial meat, chewing gum and chewing gums coatings.

In some embodiments, there is provided a personal care product, such as a cosmetic, comprising the cellulose particles of the invention. Suitable personal care products include cosmetic powders for application to skin such blusher, body powder, bronzing powder, eye shadow, face powder, lip powder, powder makeup; liquid cosmetics such bronzing product, eye pencil, eyeliner, face makeup, facial foundation, hair gel, hair paste, hair spray, lip gloss, lipstick, mascara, nail varnish, body wash, shampoo, shower gel, skin cream, sun cream, tanning products; and dental products such as tooth pastes, whitening formulations, mouthwash, dental adhesives, fillings and dental materials.

In some embodiments, there is provided a pharmaceutical composition, comprising cellulose particles of the invention. Suitable pharmaceutical compositions include any solid unit dosage form such as a pill, tablet or capsule, a pill coating such as an enteric coating, a orally disintegrating coating or a film coating; or a suppository.

In some embodiments, there is provided an ink comprising the cellulose particles of the invention.

In some embodiments, there is provided a paint comprising the cellulose particles of the invention.

In some embodiments, there is provided a washing composition comprising the cellulose particles of the invention. Suitable washing compositions include dishwasher compositions such as dishwasher powders, tablets, liquids or liquid filled pouches, or laundry compositions including laundry powders, tablets, liquids of liquid filled pouches.

The composition may comprise cellulose particles dispersed in a solvent or other formulation depending on their intended use. Suitable solvents include 2-propanol, 1,2-dichloroethane, 1,4-dioxane, 18-crown-6, 2-propanol, 2-ethoxyethanol, acetic acid, acetone, acetonitrile, ammonia, benzene, n-butanol, n-butyl acetate, chloroform, cyclohexane, dichloromethane, diethyl ether, diglyme, dimethyl formamide, Dimethyl sulfoxide, DME, ethane, ethanol, ethyl acetate, ethylene, ethylene glycol, formic acid, glycerine, heptane, hexane, hexamethylbenzene, HMDSO, HMPA, Hydrogen, Imidazole, isobutanol, isopropyl alcohol, methane, methanol, n-hexane, nitromethane n-pentane, propane, propylene, propylene carvonate, pyridine, pyrrole, pyrrolidine, silicone grease, tert-butyl alcohol, tetrahydrofuran, toluene, triethylamine, water, white spirit and xylene or a mixture thereof.

Preferably the solvent is a water-based solution or formulation.

The composition may also be an emulsion, such as a water-in-oil emulsion, an oil-in-water emulsion, a double emulsion, such as a water-in-oil-in-water emulsion or an oil-in-water-in-oil emulsion, a gel, a latex, a resin or a visco-elastic polymer matrix. The composition may optionally comprise emollients, oils, polymers, surfactants and waxes, as suited for the intended application and use.

Suitable emollients include ammonium lactate, petrolatum, salicylic acid, urea.

Suitable polymers include acrylates/steareth-20methacrylatecopolymer, aromatic polymer (such as polycarbonate, polyester, polystyrene), Carbopol®, dimethylhydantoin-formaldehyde, halogenated polymer, hydrogenatedpolydecene, keratin, para-aramid, poloxamer, polyacrylamide, polyacrylonitrile, polyaminoacid, polyamide (such as Nylon 6, Nylon 6,6, Nylon 12), polyether, polyolefin (such as but are not limited to polyethylene, polyisoprene, polypropylene, polybutadiene, polyethylene glycol), polypeptide, polymethacrylate, polymethylmethacrylate cross-polymer, polymethylsilsesquioxanes, polyquaternium, silicones, silk fibroin, silk sericin, ulvan, vinyl acetate, vinyl acetate/crotonic acid copolymer, methyl vinyl ether and maleic semester copolymer, vinylpyrrolidone. The polymer can be a cellulose- or a lignin-derivative, such as cellulose acetate, cellulose nitrate, cellophane, nitrocellulose and celluloid. The polymer can be a starch-derivative. The polymer can be a chitin-, a chitosan- or a sericin derivative. The polymer can be an alignate-, a carrageenan-, a collagen-, gelatin-, hyaluronic acid- or pectin-derivative. Preferentially the polymer is synthetised from natural feedstock and/or biobased and/or renewable monomers, and the resulting polymer is preferably biodegradable such as aliphatic polyesters, for instance poly(lactic acid) poly (ε-caprolactone), and poly(3-hydroxybutyrate-co-3 hydroxy valerate).

Suitable oils include algal oil, annatto oil, argan oil, almond oil, apricot kernel oil, avocado oil, babassu oil, Brazil nut butter, butter, cashew butter, castor oil, camellia oil, cheery kernel oil, cocoa butter, coconut oil, corn oil, cottonseed oil, fish oil, grape seed oil, gardenia oil, ghee, hazelnut oil, jatropha oil, jojoba oil, kokum oil, linseed oil, macadamia oil, maize oil, mango seed oil, mango butter, mineral oil, mink oil, olive oil, palm oil, palm kernel oil, peach kernel oil, peanut butter, peanut oil, plum kernel oil, pomegranate oil, rapeseed seed oil, rice bran oil, rosehip oil, sal oil, sesame oil, shea butter, soybean oil, squalene, sunflower oil, teas seed oil, walnut oil. Oil derivatives obtained from the aforementioned oils such as esterified oils, fatty acids, fatty alcohol, hydrogenated oils and triglycerides can be used as suitable ingredient for the said formulation. Essential oils are also suitable oils.

Suitable resin includes tosylamide formaldehyde resin and toluene-sulphonamide-formaldehyde resin.

Suitable wax include beeswax, candelilla wax, carnauba wax, Japan wax, lanolin, palm wax, paraffin.

Suitable gel includes any chemical and/or physical gel obtained from the use of thickeners such as cellulose-derivative thickener as well as acacia gum, agar, aloe gel, gelatin, guar gum, gum arabic, gum tragacanth, pectin, sodium alginate, starches, and xanthan gum.

### Uses

The invention provides a use of the cellulose particle or material comprising the cellulose particles of the present invention as a pigment, whiteness enhancer, scattering enhancer or opacifier.

These uses may be in food additives (such as pet food additives), cosmetics, personal care products, pharmaceuticals, inks, paints, coatings, laminates, washing powders, opacifiers, light harvesting devices (such as photovoltaic cells) and light distribution devices (such as LEDs).

The cellulose particles and material are particularly suitable for use as pigments owing to their ability to provide excellent diffuse whiteness and opacity.

The cellulose particles and material are also suitable as whiteness enhancers, as they have a high level of reflectance and reflect light at a similar level across the full spectrum of visible light.

The cellulose particles and materials are particularly suitable as scattering enhancers, as they exhibit excellent scattering efficiency and a very short mean free path. Scattering enhancers are particularly useful in light harvesting devices (such as photovoltaic cells) and light distribution devices (such as LEDs).

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

### EXAMPLES

Certain aspects and embodiments of the invention will now be illustrated by way of example and with reference to the figures described above.

### Materials

Microcrystalline cellulose powder (MCC) was purchased from SERVA Electrophoresis.

Filter paper was Whatman No. 1 cellulose filter paper.

Sulfuric acid (concentration>95%) was purchased from Fisher Chemical.

Trichloromethylsilane (TCMS) was purchased from Sigma Aldrich.

Ethanol (absolute) was purchased from VWR chemicals.

Carboxymethyl cellulose (CMC, MW˜90,000) was purchased from Acros.

Polyvinylidene fluoride (PVDF) membrane (average pore size 0.45 μm) was purchased from Merck Millipore Ltd.

### Preparation of Cellulose Microparticles (CMPs)

### Example 1 [CMP-L]

Cellulose microparticles were prepared by acid hydrolysis.

Cellulose microcrystalline powder (1 g) was hydrolysed with sulfuric acid (50 v/v %, 60 mL) for 5 hours at 50° C., and then quenched by adding 300 mL milli-Q water. The acid supernatant was removed by centrifugation. The hydrolysed cellulose particles were dispersed by adding 100 mL milli-Q water and then centrifuged. This process was repeated three times to remove most of the acid and the suspension of hydrolysed cellulose particles were dialyzed against milli-Q water (MWCO 12-14 kDa) for one week while changing water two times a day. The dialyzed suspension of hydrolysed cellulose particles (0.5% wt, 30 mL) was tip sonicated in an ice bath (Fisher brand ultrasonic disintegrator 500 W, 20 kHz, tip diameter 12.7 mm, amplitude 30%, 2 seconds on and 2 seconds off). The suspension was centrifuged at 2000 rpm for five minutes, and then the supernatant was collected and centrifuged at 3000 rpm for five minutes to get the cellulose nanoparticles of Example 1.

### Example 2 [CMP-M]

Cellulose nanoparticles with a slightly smaller width and length than Example 1, and a slightly higher aspect ratio than Example 1, were obtained by adjusting the concentration of sulfuric acid and temperature.

The CMPs of Example 2 were obtained using the same method as for Example 1, except the cellulose microcrystalline powder (1 g) was hydrolysed with sulfuric acid (55%, 60 mL) for 5 hours at 60° C.

### Comparative Example 3 [CMP-S]

Cellulose nanoparticles with a much smaller width and length than Examples 1 and 2 were prepared by adjusting the concentration of sulfuric acid, reaction time and temperature, and by using an alternative source of cellulose.

The CMPs of Comparative Example 3 were obtained using the same method as for Example 1, except that the cellulose microcrystalline powder was replaced by cellulose filter paper (Whatman No. 1). The cellulose filter paper (Whatman No. 1) was hydrolysed with sulfuric acid (55%, 60 mL) for 0.5 hours at 50° C.

### Comparative Example 4 [CMP-XL]

Cellulose fibres having a much larger width and length, and a much higher aspect ratio than Examples 1 and 2 were prepared from Cellulose filter paper (Whatman No. 1), which was first ground into small pieces by a coffee grinder, followed by TEMPO oxidation. 1 g of cellulose was suspended in 150 mL milli-Q water, 0.123 g TEMPO, 1.23 g NaBr and 1.23 g NaClO was added and stirred for 4.5 h at room temperature while the pH was kept at 10 by the addition of 1 M NaOH solution. The reaction was stopped by adjusting the pH to 6 with 5 M HCl, and then the oxidized cellulose fibres were washed by filtration and dialyzed against milli-Q water to provide the Cellulose fibres of Comparative Example 4.

Without wishing to be bound by theory, the TEMPO oxidation is a one-step reaction that selectively converts the hydroxyl groups on C6 of cellulose glucose ring into negatively charged carboxyl groups. It is thought that this treatment increases the repulsion force and decreases the hydrogen bonding among the native cellulose nanofibers, resulting in fibres which are less closely packed and so have a greater width.

### Size Characterization

The size distribution of the cellulose particles was measured by scanning transmission electron microscope (STEM).

A dilute suspension of CMPs (0.001 wt. %) was dropped on a carbon coated copper grid (300 mesh) for 2 minutes and removed by a piece of filter paper, then a drop of uranyl acetate solution (2%) was applied as stain for 1 minute before being removed by a piece of filter paper. The samples were measured by scanning electron microscope (SEM) with a Mira3 system (TESCAN) operated at 30 kV and a working distance of 5 mm. The length and width of nanoparticles were analysed by ImageJ.

The number of measurements taken to calculate the length is typically from 100 to 1,000. Generally, over 100 measurements of the length are taken. The number of measurements taken for the Examples can be seen by the sum of the “counts” in FIG. 2. The length is the mean average of value of all the measurements taken. The “±” is the standard deviation of the average measurement.

The length and width of the particles is provided in Table 1. The length refers to the longest dimension of the particle. The width refers to the shortest dimension of the particle.

TABLE 1
Dimensions of Cellulose Particles

| Cellulose Particles | Width | Length |
|---|---|---|
| Example 1 [CMP-L] | 520 ± 151 nm | 2,706 ± 767 nm |
| Example 2 [CMP-M] | 212 ± 64 nm | 1,944 ± 677 nm |
| Comparative Example 3 [CMP-S] | 40 ± 9 nm | 228 ± 32 nm |
| Comparative Example 4 [CMP-XL] | 20 ± 5.5 um | 547 ± 140 um |

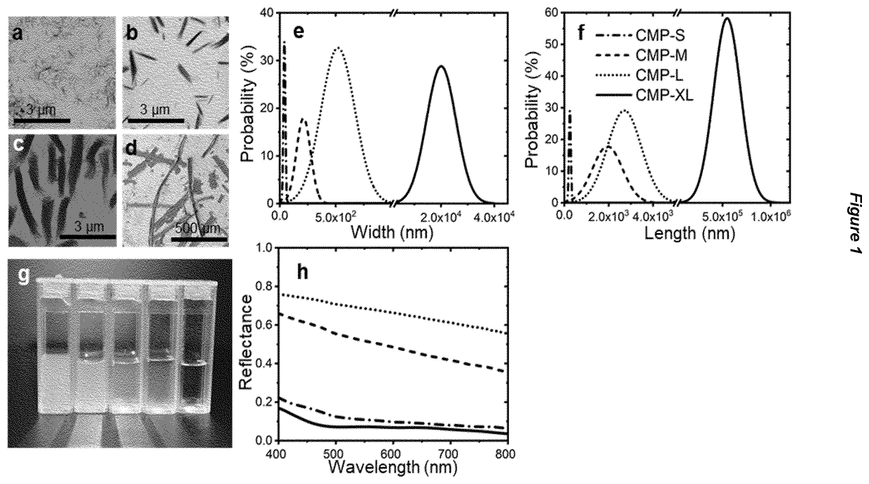

A fitted particle size distribution is shown in FIG. 1e (for the width of the particles) and FIG. 1f (for the length of the particles). Histograms and fitted normal distribution curves for the length and width of the Examples are shown in FIGS. 2a-2h. The normal distribution represents the probability of the particles having a width or length of a certain size.

The size distributions for Examples 1 and 2 are relatively narrow. It is thought that the sequential centrifugation used to prepare the particles narrows the particle size distribution.

The dimensions of the particles of Examples 1 and 2 differ significantly from traditional cellulose nanocrystals (CNCs), which are 3-5 nm in width and 100-200 nm in length (Habibi et al.), or cellulose nanofibers (CNFs), which are generally 3-20 nm in width and a several micrometers in length (Saito et al.).

Comparative Example 3 shows a much smaller cellulose particle than that in Examples 1 and 2, which is more similar in length to a traditional CNC. Comparative Example 4 is a much larger cellulose crystal, which is more similar in length to a traditional CNF.

The aspect ratio of the Examples was calculated as the ratio between the length and the width. The aspect ratios of the Examples are given in Table 2.

The average aspect ratio is the mean average value calculated from the mean average length and width (see Table 1). The maximum and minimum aspect ratio are calculated using the standard deviation length and width values (see Table 1).

TABLE 2
Aspect ratio of Cellulose Particles

| | Aspect Ratio | | |
|---|---|---|---|
| Cellulose Particles | Average | Max | Min |
| Example 1 [CMP-L] | 5.2 | 9.4 | 2.9 |
| Example 2 [CMP-M] | 9.2 | 17.7 | 4.6 |
| Comparative Example 3 [CMP-S] | 5.7 | 8.4 | 4.0 |
| Comparative Example 4 [CMP-XL] | 27.4 | 47.4 | 16.0 |

The CMPs of Examples 1 and 2 have a relatively low aspect ratio. This makes the CMPs excellent scattering enhancers. Comparative Example 3 has a similar aspect ratio to Examples 1 and 2, but is a much smaller particle, having a significantly smaller width and length (see Table 1). Comparative Example 4 has a much higher aspect ratio than Examples 1 and 2, and is also a much larger particle (see Table 1). It is thought that these differences in size and aspect ratio mean that Examples 1 and 2 show improved scattering compared to the Comparative Examples.

The aspect ratio of the particles of Examples 1 and 2 also differ from traditional cellulose nanocrystals (CNCs) which generally have an aspect ratio of from 20 to 40 (Habibi et al.) or cellulose nanofibers (CNFs), which generally have an aspect ratio of 50 or more (Saito et al.).

Without wishing to be bound by theory, it is thought that the difference in the size and the relatively low aspect ratio results in different scattering abilities of the particles, making the CMPs of Example 1 and 2 excellent scattering enhancers.

### Microscopy Characterization

FIG. 1 shows STEM images of the CMPs in solution, for (a) Comparative Example 3, (b) Example 2, (c) Example 1, and (d) Comparative Example 3.

The STEM images are obtained using a Mira3 FEG-SEM system (TESCAN) operated at 30 kV and a working distance of 5 mm.

### Whiteness of Particles in Solution

FIG. 1g shows suspensions of CMPs of different sizes dispersed in water with a fixed concentration (0.1 wt. %). From left to right, FIG. 1g shows Example 1, Example 2, Comparative Example 3, Comparative Example 4, and pure water as a control.

The efficiency of the CMPs of Examples 1 and 2 as single scatterers can be observed by the whiteness of the samples compared to the control. The Comparative Examples 3 and 4 show some whiteness, but they are clearly less white than Examples 1 and 2. The whiteness observed in the macroscopic image of the particle suspensions is a direct indicator of the scattering ability of the single particles, and also of the usefulness of the particles as a white colourant.

### Optical Reflectance Testing of Particles in Solution

FIG. 1h shows the optical reflectance of Examples 1, 2 and Comparative Examples 3 and 4. This is measured for CMPs of different sizes dispersed in water with a fixed concentration (0.1 wt. %) using the method described herein.

The total transmittance and reflectance measurements were performed with an integrating sphere (Labsphere). A light source (Ocean Optics HPX-2000) was coupled into an optical fiber (600 μm Thorlabs FC-UV100-2-SR) via a collimator (Thorlabs) and the signal was collected by a spectrometer (Avantes HS2048), as shown in FIG. 8 (T₁ and T₂). The signal was normalized with respect to the intensity when no sample was mounted. The background was recorded when no light was applied. The range of wavelengths was between 400 and 800 nm. Five spectra were taken for each sample and averaged to reduce the signal-to-noise ratio. Each spectrum was recorded using an integration time equal to 3 s.

The particles of Examples 1 and 2 show a much higher reflectance across the visible light spectrum (400-800 nm) than Comparative Examples 3 and 4.

The size and aspect ratio of the particles in Examples 1 and 2 result in good scattering of white light. Smaller or larger particles, or those with a higher aspect ratio, show a reduced reflectance because of decreased scattering strength.

It is though that Example 1 has an angular distribution of the scattered light, which is asymmetric (Mie-scattering), while in contrast for Comparative Example 3 the scattering is symmetric Rayleigh scatterers. This may explain the difference in scattering strength.

### Preparation of Dry Powder of Cellulose Microparticles

A dried CMP powder was prepared from CMPs of Example 1.

The CMPs of Example 1 [CMP-L]were redispersed in water at a concentration of 0.1 wt. % (following centrifugation), to provide an aqueous suspension of cellulose particles.

The pH of the aqueous suspension of cellulose particles was adjusted by addition of NaOH. The pH was adjusted to a pH 7.0. pH can be measured as discussed above.

The aqueous suspension of cellulose particles was then freeze-dried (VirTis freeze dryer by SP Scientific) to remove water from the suspension of cellulose particles, to provide a powder of cellulose particles of Example 1.

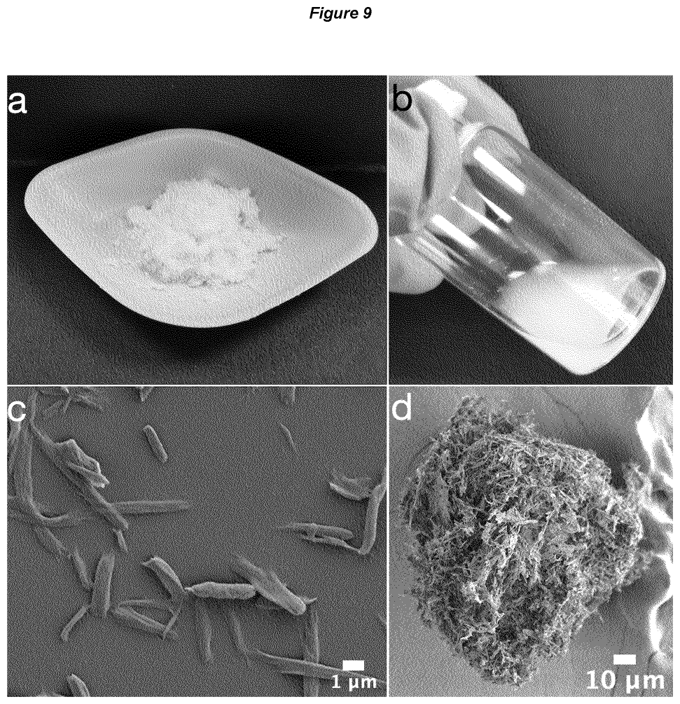

An image of the dried CMP powder is shown in FIG. 9a.

The powder is flowable and substantially free of solvent. This dry powder form of the CMPs is useful for commercially applications where the powder is added to a product composition.

### Re-Dispersion of Dry Powder of Cellulose Microparticles

A suspension of the CMPs was prepared by re-dispersing the dried CMP powder in water. 1 ml of water was added to 0.01 g of dry CMP powder prepared as described above.

The mixture was ultrasonicated to disperse the CMP powder in the water, to provide a suspension.

FIG. 9b shows an image of the suspension of the CMPs. The suspension is white, homogeneous and translucent.

The dry CMP powder readily formed a suspension when it was added to the water. Only mild mechanical agitation was applied to form the suspension, in the form of ultrasonication.

FIG. 9c shows a SEM image of the dry CMP powder in the aqueous suspension.

The STEM images are obtained using a Mira3 FEG-SEM system (TESCAN) operated at 30 kV and a working distance of 5 mm.

The STEM image of the suspension shows that the dried and re-dispersed CMPs of Example 1 (shown in FIG. 9c) are substantially unchanged from the CMPs of Example 1 prepared directly from the fractionation step (STEM image shown in FIG. 1c). The size and shape of the CMPs is shown to be largely unchanged as a result of the drying and re-dispersing steps.

### Preparation of Clusters of Cellulose Microparticles

A dried CMP cluster was prepared from CMPs of Example 1 [CMP-L].

The CMPs of Example 1 were redispersed in water at a concentration of 0.01 wt. % (following centrifugation), to provide an aqueous suspension of cellulose particles.

The pH of the aqueous suspension of cellulose particles was adjusted by addition of NaOH. The pH was adjusted to a pH 7.0. pH can be measured as discussed above.

The aqueous suspension of cellulose particles was then spray-freeze dried. The suspension was spray dried using a spray coater (PrecisionCoat spray coater by Specialty Coating Systems) into liquid nitrogen. The frozen clusters were then collected from the liquid nitrogen, and freeze-dried (VirTis freeze dryer by SP Scientific) to provide a cluster of cellulose particles of Example 1.

An SEM image of the dried CMP cluster is shown in FIG. 9d. The STEM images are obtained using a Mira3 FEG-SEM system (TESCAN) operated at 30 kV and a working distance of 5 mm.

The SEM image in FIG. 9d shows a cluster having a sphere-like shape. The cluster has a diameter of around 100 μm. The CMPs are randomly orientated and are separated by a network of pores.

### Preparation of Films of Cellulose Microparticles

### Examples 1F, 2F and Comparative Example 3F

White films Example 1 F, Example 2F and Comparative Example 3F were prepared from CMPs of Example 1, Example 2 and Comparative Example 3 respectively.

The white films of the CMPs were fabricated by vacuum filtration on a hydrophilic polyvinylidene fluoride (PVDF) membrane. The filling fraction and thickness of the films were controlled by the initial amount of microparticles and the duration of the vacuum process.

80 ml of a suspension of cellulose microparticles at a concentration of 0.1 wt. % was vacuum filtrated until a wet film with no visible water layer was formed. The suspension was continuously vacuumed for between 15 and 30 minutes. The time was varied depending on the strength of the vacuum.

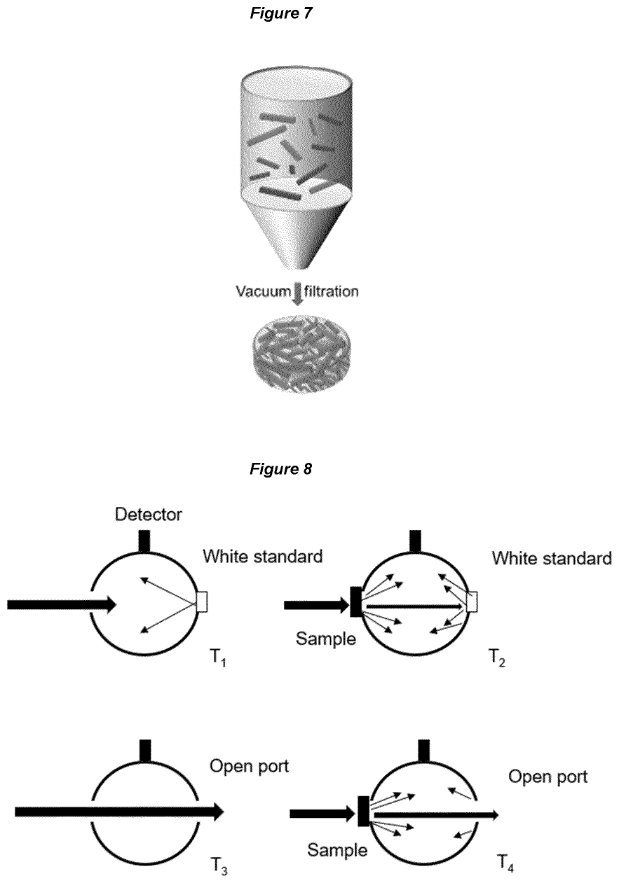

As the suspension of CMPs is filtered through the membrane, when the water is removed, CMPs will form a percolated network. This process is shown in the schematic diagram of FIG. 7.

The filter membrane with the attached wet film was carefully taken off and transferred into liquid nitrogen. The frozen film was then freeze-dried (VirTis freeze dryer by SP Scientific) and removed from the filter membrane to yield a free-standing film.

Films of various thicknesses and filling fractions were prepared, as shown in Table 3. The thickness and/or the filling fraction of CMPs can be adjusted by the filtration time (or the amount of water that is removed).

TABLE 3
Films

| | Cellulose | Filling | Thickness |
|---|---|---|---|
| ID | Particles | fraction (%) | (μm) |
| Example 1F.1 | Example 1 | 40 | 9 |
| Example 1F.2 | Example 1 | 53 | 9 |
| Example 1F.3 | Example 1 | 25 | 25 |
| Example 1F.4 | Example 1 | 40 | 10 |
| Example 1F.5 | Example 1 | 40 | 15 |
| Example 1F.6 | Example 1 | 40 | 20 |
| Example 1F.7 | Example 1 | 40 | 30 |
| Example 2F.1 | Example 2 | 25 | 25 |
| Comparative | Comparative | 25 | 25 |
| Example 3F.1 | Example 3 | | |

The cross-section of each film was measured by scanning electron microscope (SEM) with a Mira3 system (TESCAN) operated at 5 kV and a working distance of about 6 mm. To prepare specimens, the films were frozen in liquid nitrogen and then divided into flakes. The samples were mounted on aluminium stubs using conductive carbon tape and coated with a layer of platinum (10 nm in thickness) by a sputter coater (Quorum Q150T ES). The thickness of each film was determined from SEM images of their cross-sections.

The filling fraction (ff) was calculated using a nominal density ρ of 1.5 g/cm⁻³ for cellulose, the volume of cellulose nanoparticles v₁=m/ρ (m is the weight of films). The volume of films v₂=πr²d was estimated by using the average thickness of films d and r is the radius of films. The filling fraction is calculated by ff=v₁/v₂.

### Comparative Example 4F

A white film of Comparative Example 4F was prepared from CMPs of Comparative Example 4.

The CMPs of Comparative Example 4 were mixed with 1% CMC solution at various weight ratios. The mixture was firstly degassed in a vacuum chamber, then was cast on a petri dish to obtain a free-standing film. This provided a film of Comparative Example 4F.

### Microscopy Characterization

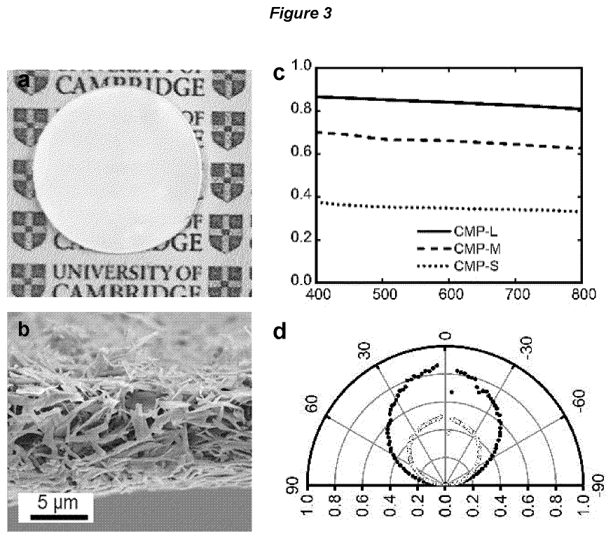

FIG. 3a shows a picture of a typical white film of Example 1 F.1 made from particles of Example 1 and having a thickness of 9 μm. The text underneath the film in FIG. 3a is hard to be resolved even when the centre part of the film is closely touched with the background paper.

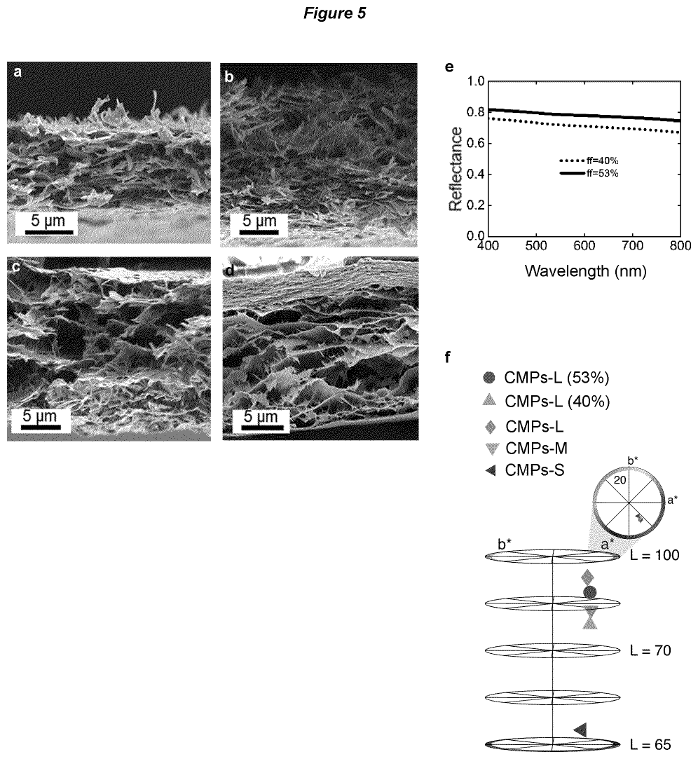

SEM images shown in FIG. 3b and FIG. 5a show the cross-section of Example 1 F.1 and Example 1 F.2 (with a thickness of 9 μm and filling fractions of 40% and 53% respectively).

SEM images shown in FIG. 5 show the cross-section of white films of Example 1 F.3 (FIG. 5b), Example 2F.1 (FIG. 5c) and Comparative Example 3F.1 (FIG. 5d), all having a thickness of 25 μm and a filling fraction of 25%.

It can be seen that the films prepared from Comparative Example 3F, which have the smallest particle size (about 40 nm in width and 228 nm in length) are prone to pack more densely than films of Examples 1 F and 2F.

It is thought that the vacuum force applied on the bottom of the wet film is stronger than the surface of the film, creating the gradient in filling fraction across the width of the film. Without wishing to be bound by theory, it is thought that the random 3D network in the films is due to the hydrogen bonding formed between the CMPs, and the micropores are the results of the formation of ice crystals during the freezing step.

It is also thought that ice crystals formed during the freeze-drying step of film formation push the CMPs at the domain boundaries between different ice crystals, leading to the formation of layered sheets of CMPs. In films with larger particles, such as Examples 1 F and 2F, the films are less prone to this process, hence the absence of flakes and layers in the SEM images (see FIGS. 5a, 5b and 5c). Smaller particles such as Comparative Example 3F are more prone to the effect of the ice crystal formation, so form layer and flakes, as seen in FIG. 5d.

### Optical Reflectance

The total transmittance and reflectance measurements were performed with an integrating sphere (Labsphere). A light source (Ocean Optics HPX-2000) was coupled into an optical fiber (600 μm Thorlabs FC-UV100-2-SR) via a collimator (Thorlabs) and the signal was collected by a spectrometer (Avantes HS2048), as shown in FIG. 8 (T₁ and T₂). The signal was normalized with respect to the intensity when no sample was mounted. The background was recorded when no light was applied. The range of wavelengths was between 400 and 800 nm. Five spectra were taken for each sample and averaged to reduce the signal-to-noise ratio. Each spectrum was recorded using an integration time equal to 3 s.

FIG. 3c shows the optical reflectance of films made with Examples 1 F.3 and 2F.1, and Comparative Example 3F.1. The thickness of the films was 25 μm and the filling fraction was 0.25. Examples 1 F.3 and 2F.1 show a reflectance of 80% or more and 60% or more respectively, which is significantly larger than that of Comparative Example 3F.1 which can reflect 40% or less across the 400 nm to 800 nm wavelength range. The reflectance of the films of Examples 1 F and 2F are superior across the visible spectrum compared to comparative Example 3F.

The degree of reflectance of the films corresponds to that seen for the particles in solution.

FIG. 5e shows the optical reflectance of films made with Example 1 F.1 and 1F.2, with a thickness of 9 μm and a filling fraction of 40% and 53%. Increasing the filling fraction leads to an increase of reflectance from around 71% to 77% at 600 nm.

### Optical Transmittance and Whiteness

The scattering efficiency of the films of Examples 1 F and 2F, Comparative Example 3F and cellulose nanofibers having different thicknesses were measured. This allows the transport mean free path to be precisely estimated.

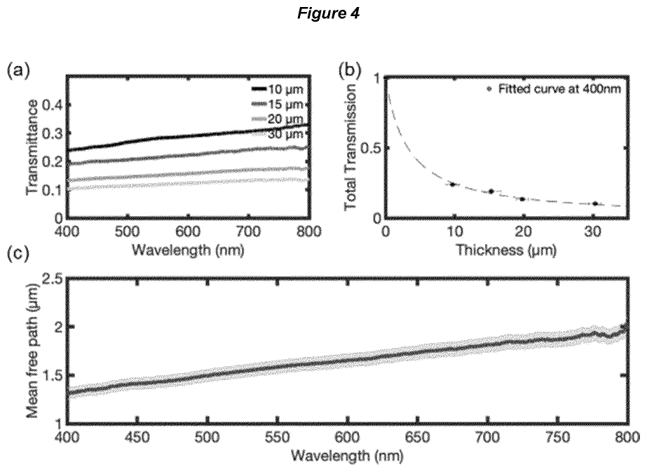

FIG. 4a shows the transmittance for Example 1F.4, 1F.5, 1 F.6 and 1F.7 having a filling fraction of 40%, and thicknesses of 10 μm, 15 μm, 20 μm and 30 μm respectively. FIG. 4b shows the transmittance at different thicknesses for incident light at a wavelength of 400 nm. FIG. 4c shows the wavelength dependency of the transport mean free path (It) for Example 1 F.1. The transport mean free path was almost wavelength-independent, resembling the shape of the total transmission spectra. This is indicative of excellent scattering efficiency by the film.

The whiteness of the films is shown in FIG. 5f. The scattering response for Example 1 F.1, 1F.2, 1F.3, 2F.1 and Comparative Example 3F.1 is shown in terms of spectral dependence. Whiteness is optimized by increasing the amount of light reflected at different wavelengths and it can be calculated by converting the reflectance spectra in La*b* colour-space coordinates (Jacucci et al.). Films with CMPs of different sizes have a similar colour saturation, i.e., the radial distance from the centre of coordinates (a*, b*) is similar. However, the CMPs of different sizes do show very different luminosities, i.e., vertical coordinate (L*) differs.

The scattering efficiency of the CMP films, in terms of their transport mean free path and whiteness (luminosity, L*) is summarized in Table 4. The mean free path is the average mean free path over a wavelength of from 400 to 800 nm.

CNF (in Table 4) refers to the cellulose nanofibers prepared in Syurik et al.

TABLE 4
Mean free path and whiteness of films

| | | Film | | Whiteness |
|---|---|---|---|---|
| | Filling | thickness | Mean free | (Luminosity, |
| ID | fraction | (μm) | path - 1ₜ (μm) | L*) |
| Example 1F.1 | 0.40 | 9 | 1.6 ± 0.1 | 84 |
| Example 1F.2 | 0.53 | 9 | 1 | 88 |
| Example 1F.3 | 0.25 | 25 | 2.5 | 89 |
| Example 2F.1 | 0.25 | 25 | 7 | 83 |
| Comparative | 0.25 | 25 | 20 | 66 |
| Example 3F.1 | | | | |
| CNFs | — | 9 | — | 86 |

FIG. 4C shows a graph of mean free path for Example 1 F.1 over the visible range (wavelength of 400-800 nm).

The transport mean free path was evaluated from the total transmission data by means of the following equation, as described in Syurik et al.

$$T = \frac{2 {z}_{e} {l}_{t}}{L + 2 {z}_{e} {l}_{t}}$$

Where T, L, lₜ and zₑ are the total transmission, thickness, mean free path and extrapolation length, respectively. This latter parameter takes into account internal reflections at the sample's interfaces on the evaluation of the mean free path and can be calculated by knowing the filling fraction system (Jacucci et al.).

The mean free path represents the average distance that light has to travel in a medium before its initial propagation direction is randomized and is inversely proportional to the scattering efficiency. Therefore, the transport mean free path is a good measure of the scattering response of different materials independent of the sample structural parameters. Table 4 shows that the Examples 1 F.1, 1F.2 and 1F.3 exhibit a value of transport mean free path of 2.5 μm or less, and as low as 1 μm, which is exceptionally small for low refractive index scattering media. Example 2F also shows a low mean free path of 7 μm. The mean free paths of Examples 1 F and 2F are notably lower than Comparative Example 3F, which has a mean free path of 20 μm.

The whiteness of Example 1 F and 2F are all in excess of L*=0.83. This is indicative of a very high level of scattering efficiency. In contrast, the CMP film of Comparative Example 3F has a whiteness of only L*=0.66, which is suggests the scattering efficiency is poorer.

### Angular Dependence of Films

The angular distribution of reflected/transmitted light shown was determined using a goniometer. A Xenon lamp (Ocean Optics HPX-2000) was coupled into an optical fiber (Thorlabs FC-UV100-2-SR) and shone onto the sample. The illumination angle was fixed at normal incidence and the angular distribution of intensity was acquired by rotating the detector arm around the sample with a resolution of 1°. To detect the signal, a 600 μm core fiber (Thorlabs FC-UV600-2-SR) connected to a spectrometer (Avantes HS2048) was used. The spectra were averaged over 10 acquisitions to reduce the signal-to-noise ratio.

The optical response of Example 1F having a thickness of 10 μm and 40 μm was evaluated in terms of angular dependence (see FIG. 3d). The angular distribution of reflected light was determined using a goniometer setup. The illumination angle was fixed at normal incidence and the angular distribution of intensity was acquired by rotating the detector arm around the sample. The wavelength used was 400 nm. Intensity was normalized to a white diffuser. FIG. 3d shows that Example 1 F follows a Lambertian profile of the ideal diffuser, even for a very thin film of 10 μm thickness.

### Hydrophobic Preparation of Films of Cellulose Microparticles

The Cellulose microparticles of Example 1 were treated with methyltrichlorosilane (TCMS) vapor. Freeze-dried CMPs of Example 1 were put in the upper space of a chamber with 1 mL TCMS liquid for 30 seconds. After TCMS treatment, CMPs were dispersed in ethanol by sonication, and then films were formed by drop-casting this suspension in the air at room temperature.

This resulted in a hydrophobic film, Example 1 FH, for which the water droplet contact angle is over 90°. The films are thus useful for white coatings in a range of applications, where antifouling and self-clean white coatings are desirable.

This is an alternative, simplified and scalable method to produce highly scattering films that allows removing the filtration, freezing and freeze-drying steps. This method is illustrated by the schematic in FIG. 6a.

It is thought that, when treated with TCMS, part of the hydroxyl groups on the surface of CMPs are replaced by —O—Si(CH₃)₃ moieties, so the hydrogen bonding between hydroxyl groups is significantly reduced during the drying process. Without wishing to be bound by theory, due to the reduced hydrogen bonding and the lower surface tension of ethanol with respect to water, a porous network of CMPs can be achieved in a thin film without collapsing under the capillary pressure produced by the solvent evaporation.

### Characterisation of Hydrophobic Films

For Example 1, FH with a thickness of 25 μm, the reflectivity ranged from 84% at 400 nm to 88% at 800 nm (see FIG. 6b).

Moreover, these highly scattering films of Example 1 FH show a good hydrophobic response.

The contact angle (CA, 6) was measured by using a drop shape analysis instrument (First Ten Angstroms, USA) at ambient temperature. A water droplet of 5 μL was placed on the surface of a sample, and the contact angle was an average of six measurements on different positions on the surface. FIG. 6b (inset image) shows a SEM image of the cross-section of the hydrophobic film and a contact angle profile of a water droplet on the surface of the film. The water droplet contact angle of these film is 140° which is close to what is achieved with a superhydrophobic surface.

This widens the potential for application for these films as an antifouling and self-cleaning white coating.

### REFERENCES

A number of publications are cited above in order to more fully describe and disclose the invention and the state of the art to which the invention pertains. Full citations for these references are provided below. The entirety of each of these references is incorporated herein.
Credou, J.; Berthelot, T. Sci. Rep. 2017, 7, 40373.
Credou, J.; Berthelot, T. J. Mater. Chem. B 2014, 2 (30), 4767-4788.
Habibi et al. Chem. Rev. 2010, 110 (6), 3479-3500.
Jacucci et al. Adv. Opt. Mater. 2019, 7 (23), 1900980.
Miyamoto, T.; Takahashi, S.; Ito, H.; Inagaki, H.; Noishiki, Y. J. Biomed. Mater. Res. 1989, 23 (1), 125-133.
Saito et al. Biomacromolecules 2006, 7, 1687
Syurik et al. Adv. Funct. Mater. 2018, 28 (24), 170690
Tao, et al., J. Mater. Chem. 2011, 21 (46), 18623-18629
Toivonen et al. Adv. Mater. 2018, 30 (16), 1704050
Zhu et al. ACS Nano 2016, 10 (1), 1369-1377
CN 102276734
CN 106699904
CN 112280072
CN 113150319
CN 113152150
CN 113174091
CN 113480756
EP 3854819
US 2013/303750
US 2021/213405
WO 2012/06720
WO 2019/063647

1. A cellulose particle having a length of from 1,000 to 10,000 nm and an aspect ratio of from 2 to 18.

2. The cellulose particle of claim 1, wherein the aspect ratio is from 3 to 15.

3. The cellulose particle of claim 1, wherein the cellulose particle has a length of from 1,000 to 5,000 nm.

4. The cellulose particle of claim 1, wherein the cellulose particle has a width of from 200 to 1,000 nm.

5. The cellulose particle of claim 1, wherein the cellulose particle has a rod or a rod-like shape, or a flake or a flake-like shape.

6. The cellulose particle of claim 1, wherein the particles in a population of the cellulose particles have a mean average length of from 1,000 to 5,000 nm.

7. The cellulose particle of claim 1, wherein the particles in a population of the cellulose particles have a D50 length of from 1,000 to 5,000 nm.

8. The cellulose particle of claim 1, wherein the particles in a population of the cellulose particles have an aspect ratio between the mean average length of the particle and the mean average width of the particle of from 2 to 18.

9. The cellulose particle of claim 1, wherein the particles in a population of the cellulose particles have a D50 width of from 200 to 1,000 nm.

10. The cellulose particle of claim 1, wherein the particles in a population of the cellulose particles have a particle length standard deviation of 1,000 nm or less.

11. The cellulose particle of claim 1, wherein the particle comprises one or more silylether groups on the surface of the particle, such as one or more —O—Si(CH₃)₃ or —O—Si(OCH₃)₃ groups.

12. A method of preparing a cellulose particle comprising the steps of:
(a) hydrolysing a cellulose material with a protic inorganic acid having a concentration of from 40 to 60 v/v % at a temperature of from 40 to 60° C. to provide hydrolysed cellulose particles;
(b) washing the hydrolysed cellulose particles; and
(c) fractioning a suspension of the hydrolysed cellulose particles using differential centrifugation comprising a first centrifugation and a second centrifugation, wherein the first centrifugation is at a lower relative centrifugal force than the second centrifugation.

13. The method of claim 12, wherein the protic inorganic acid is sulfuric acid.

14. The method of claim 12, wherein the cellulose material is a microcrystalline cellulose powder.

15. The method of claim 12, wherein in step (a) the cellulose material is hydrolysed for from 1 to 10 hours, such as about 5 hours.

16. The method of claim 12, wherein step (b) comprises dialyzing the hydrolysed cellulose particles with water.

17. The method of claim 12, wherein the first centrifugation is at a relative centrifugal force of from 50 to 1,500 and the second centrifugation is at a relative centrifugal force of from 600 to 2,600.

18. The method of claim 12, wherein the first centrifugation is at a relative centrifugal force of from 150 to 1,500, and the second centrifugation is at a relative centrifugal force of from 1,000 to 2000.

19. The method of claim 12, wherein the method further comprises a step (d) of drying the fractionated cellulose particles.

20. The method of claim 19, wherein the step (d) of drying the fractionated cellulose particles comprises spray drying, freeze drying or spray-freeze drying the fractionated cellulose particles to provide a dry powder of cellulose particles or a cluster comprising the cellulose particles.

21. The method of claim 12, further comprising a step of treating the cellulose particles with trimethylchlorosilane or chlorotrimethoxysilane to provide the cellulose particles with one or more —O—Si(CH₃)₃ or —O—Si(OCH₃)₃ surface groups.

22. A cellulose particle obtained or obtainable by the method of claim 12.

23. The cellulose particle of claim 1, having a reflectance of 25% or more of incoming light at a wavelength of from 400 to 800 nm, when the cellulose particles are dispersed in water at a concentration of 0.1 wt % and have a light path length of 1 cm.

24. A cluster comprising the cellulose particles of claim 1.

25. The cluster of claim 24, having an aspect ratio of from 1 to 2 and a length of from 1.0 μm to 100 μm.

26. The cluster of claim 24, wherein a population of the clusters has a mean average length of from 1.0 μm to 100 μm, and/or a mean average aspect ratio of from 1 to 2.

27. A cluster obtained or obtainable by the method of claim 20.

28. A film comprising the cellulose particles of claim 1.

29. The film of claim 28, having a thickness of from 5.0 to 40.0 μm.

30. The film of claim 28, wherein the film has a filling fraction of from 20 to 60%.

31. The film of claim 28, wherein the film has a reflectance of 50% or more of incoming light at a wavelength of from 400 to 800 nm.

32. The film of claim 28, wherein the film has an L* of 70 or more, such as 75 or more, such as 80 or more, wherein L* is a CEILAB colour-space coordinate.

33. A composition comprising a suspension of cellulose particles of claim 1, a suspension of clusters of comprising the cellulose particles, or a suspension of flakes formed by dividing a film comprising the cellulose particles.

34. The composition of claim 33, wherein the suspension of cellulose particles is pH adjusted to a pH of 7 prior to forming the composition.

35. A pigment, a whiteness enhancer, a scattering enhancer or an opacifier comprising the cellulose particles of claim 1, clusters comprising the cellulose particles, or flakes formed by dividing a film comprising the cellulose particles, as a pigment, a whiteness enhancer, a scattering enhancer or an opacifier.
